(19) United States
(12) Patent Application Publication
(10) Pub. No.: US 2017/0366236 A1
(43) Pub. Date: Dec. 21, 2017

(54) METHOD AND APPARATUS FOR PAGING USING BEAMFORMING IN WIRELESS COMMUNICATION SYSTEM

(71) Applicant: Samsung Electronics Co., Ltd., Gyeonggi-do (KR)

(72) Inventors: Sunheui Ryoo, Yongin-si (KR); Jungsoo Jung, Seongnam-si (KR); Sungjin Lee, Bucheon-si (KR); Jiwon Hwang, Suwon-si (KR); Rayeon Ahn, Seoul (KR)

(21) Appl. No.: 15/624,679

(22) Filed: Jun. 15, 2017

(30) Foreign Application Priority Data
Jun. 15, 2016 (KR) 10-2016-0074688
Jul. 4, 2016 (KR) 10-2016-0084404

(51) Int. Cl. H04B 7/04; H04W 72/00; H04N 7/173

(52) U.S. Cl. CPC H04B 7/043; H04W 72/005; H04B 7/0421; H04N 7/17318

(57) ABSTRACT

The present disclosure relates to a system and communication technique of fusing a 5G communication system supporting higher data transmission rate than a 4G system with an IoT technology. The present disclosure may be applied to intelligent services (e.g., smart home, smart building, smart city, smart car or connected car, health care, digital education, retail business, security and safety related service, or the like). According to embodiments of the present disclosure, a method for paging using beamforming by a base station in a wireless communication system may include: determining a paging option for a terminal based on at least one of whether a cell is in a dormant mode, information on a number of terminals within the cell, or traffic load information of the cell, notifying the terminal of information on the determined paging option, and performing a paging operation on the terminal based on the determined paging option.

### CROSS-REFERENCE TO RELATED APPLICATIONS AND CLAIM OF PRIORITY

The present application is related to and claims priority under 35 U.S.C. 119(a) to applications filed in the Korean Intellectual Property Office on Jun. 15, 2016, and Jul. 4, 2016, and assigned Serial Nos. 10-2016-0074688, and 10-2016-0084404, respectively, the contents of which are incorporated herein by reference.

### TECHNICAL FIELD

Various embodiments of the present disclosure relate to a method and an apparatus for paging using beamforming in a wireless communication system.

### BACKGROUND

To meet a demand for radio data traffic that is on an increasing trend since commercialization of a 4G communication system, efforts to develop an improved 5G communication system or a pre-5G communication system have been conducted. For this reason, the 5G communication system or the pre-5G communication system is called a communication system beyond 4G network or a system since the post LTE. To achieve a high data transmission rate, the 5G communication system is considered to be implemented in a super high frequency (mmWave) band (e.g., like 60 GHz band). To alleviate a path loss of a radio wave and increase a transfer distance of the radio wave in the super high frequency band, in the 5G communication system, beamforming, massive MIMO, full dimensional MIMO (FD-MIMO), array antenna, analog beam-forming, and large scale antenna technologies have been discussed. Further, to improve a network of the system, in the 5G communication system, technologies such as evolved small cell, advanced small cell, cloud radio access network (cloud RAN), ultra-dense network, device to device communication (D2D), wireless backhaul, moving network, cooperative communication, coordinated multi-points (CoMP), and received interference cancellation have been developed. In addition, in the 5G communication system, hybrid FSK and QAM modulation (FQAM) and sliding window superposition coding (SWSC) that are an advanced coding modulation (ACM) scheme and a filter bank multi carrier (FBMC), a non orthogonal multiple access (NOMA), and a sparse code multiple access (SCMA) that are an advanced access technology, and so on have been developed.

Meanwhile, the Internet is evolved to an Internet of Things (IoT) network that transmits and receives information, such as things, between distributed components and processes the information, in a human-centered connection network through which a human being generates and consumes information. The Internet of Everything (IoE) technology in which the big data processing technology, etc., by connection with a cloud server, etc., is combined with the IoT technology has also emerged. To implement the IoT, technology elements, such as a sensing technology, wired and wireless communication and network infrastructure, a service interface technology, and a security technology, have been required. Recently, technologies such as a sensor network, machine to machine (M2M), and machine type communication (MTC) for connecting between things has been researched. In the IoT environment, an intelligent Internet technology (IT) service that creates a new value in human life by collecting and analyzing data generated in the connected things may be provided. The IoT may be applied to fields, such as a smart home, a smart building, a smart city, a smart car or a connected car, a smart grid, health care, smart appliances, and an advanced healthcare service, by fusing and combining the existing information technology (IT) with various industries.

Therefore, various attempts to apply the 5G communication system to the IoT network have been conducted. For example, technologies such as the sensor network, the machine to machine (M2M), and the machine type communication (MTC), have been implemented by techniques such as the beamforming, the MIMO, and the array antenna that are the 5G communication technologies. The application of the cloud radio access network (cloud RAN) as the big data processing technology described above may also be considered as an example of the fusing of the 5G technology with the IoT technology.

The 5G technology defines an energy-efficient operation to achieve the main goal of improving power efficiency of terminal and base station networks. For this purpose, in order to solve the possibility of additional power consumption due to a beamforming transmission method, which is indispensable in operation of a high frequency band, control discussions have been started to reduce a measurement operation and an activation operation time of the corresponding cell.

### SUMMARY

To address the above-discussed deficiencies, it is a primary object to provide a method for improving power waste occurring by transmitting a control signal and paging to all terminals within a cell by a full beam sweep.

Objects of the present disclosure are not limited to the above-mentioned objects. That is, other objects that are not mentioned may be understood by those skilled in the art to which the present disclosure pertains from the following description.

Various embodiments of the present disclosure are directed to the provision of a method for paging using beamforming by a base station in a wireless communication system, comprising: determining a paging option for a terminal based on at least one of whether a cell is in a dormant mode, information on the number of terminals within the cell, and traffic load information of the cell; notifying the terminal of information on the determined paging option; and performing a paging operation on the terminal based on the determined paging option.

Various embodiments of the present disclosure are directed to the provision of a base station supporting beamforming in a wireless communication system, comprising: a transceiver; and at least one processor configured to determine a paging option for a terminal based on at least one of whether a cell is in a dormant mode, information on the number of terminals within the cell, and traffic load information of the cell, notify the terminal of information on the determined paging option; and perform a paging operation on the terminal based on the determined paging option.

Various embodiments of the present disclosure are directed to the provision of a method for paging using beamforming of a terminal in a wireless communication system, comprising: receiving information on a determined paging option from a base station; and receiving a paging message from the base station based on the paging option, in which the determined paging option is based on at least one of whether a cell is in a dormant mode, information on the number of terminals within the cell, and traffic load information of the cell.

Various embodiments of the present disclosure are directed to the provision of a terminal supporting beamforming in a wireless communication system, comprising: a transceiver; and at least one processor configured to control the transceiver to receive information on a determined paging option from a base station and receive a paging message from the base station based on the paging option, in which the determined paging option is based on at least one of whether a cell is in a dormant mode, information on the number of terminals within the cell, and traffic load information of the cell.

According to various embodiments of the present disclosure, it is possible to save the power consumption of the terminal by performing the control to effectively reduce the control signal or the paging signal broadcast to all the terminals by the full beam sweep in the high frequency band.

In addition, according to various embodiments of the present disclosure, it is possible to improve the use efficiency of the network radio resource, reduce the power consumption of the base station, and reduce the neighboring interference between the 5G cells by restrictively performing the full beam sweep transmitting operation on the common control signal.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a diagram illustrating a beamforming operation in a high frequency band.

FIG. 2 is a diagram illustrating a paging operation between a terminal and a base station.

FIG. 3 is a diagram illustrating a paging-related operation in a wireless communication system according to an embodiment of the present disclosure.

FIG. 4 is a diagram illustrating an example of a frame structure in a high frequency band according to an embodiment of the present disclosure.

FIG. 5 is a diagram illustrating a paging operation based on a first paging option (full sweep paging) according to an embodiment of the present disclosure.

FIG. 6 is a diagram illustrating a paging operation based on a second paging option (dedicated paging) according to an embodiment of the present disclosure.

FIG. 7 is a flow chart illustrating a paging option determination operation of a base station according to an embodiment of the present disclosure.

FIG. 8 is a diagram illustrating the operation of the base station in the first paging option according to the embodiment of the present disclosure.

FIG. 9 is a diagram illustrating the operation of the base station in the second paging option according to the embodiment of the present disclosure.

FIG. 10 is a diagram illustrating the operation of the terminal in the first paging option according to the embodiment of the present disclosure.

FIG. 11 is a diagram illustrating the operation of the terminal in the second paging option according to the embodiment of the present disclosure.

FIG. 12A is a diagram illustrating an operation according to a multiple-step paging signal transmission in the first paging option according to the embodiment of the present disclosure.

FIG. 12B is a diagram illustrating a paging operation based on terminal grouping according to a best beam according to an embodiment of the present disclosure.

FIG. 13 is a block diagram schematically illustrating a configuration of a base station according to an embodiment of the present disclosure.

FIG. 14 is a block diagram illustrating a configuration of a terminal according to an embodiment of the present disclosure.

FIG. 15 is a diagram illustrating a movement of a terminal of a mobile communication system.

FIG. 16 is a diagram illustrating a terminal management method using a tracking area (TA) in the mobile communication system.

FIG. 17 is a diagram illustrating another terminal management method using the TA in the mobile communication system.

FIG. 18 is a diagram illustrating a method for connecting and disconnecting a terminal to a communication system.

FIG. 19 is a diagram illustrating another method for connecting and disconnecting a terminal to a communication system.

FIGS. 20A and 20B are diagrams illustrating a method for operating a terminal for connecting a terminal in an idle state to a system.

FIGS. 21A and 21B are diagrams illustrating a method for operating a system for connecting the terminal in the idle state to a system.

FIG. 22 is a diagram illustrating a method for providing beam information according to an embodiment of the present disclosure.

FIG. 23 is a diagram illustrating an operation of a terminal receiving beam information according to an embodiment of the present disclosure.

FIG. 24 is a diagram illustrating an operation of a base station transmitting beam information according to an embodiment of the present disclosure.

FIG. 25 is a diagram illustrating a terminal according to an embodiment of the present disclosure.

FIG. 26 is a diagram illustrating a base station according to an embodiment of the present disclosure.

### DETAILED DESCRIPTION

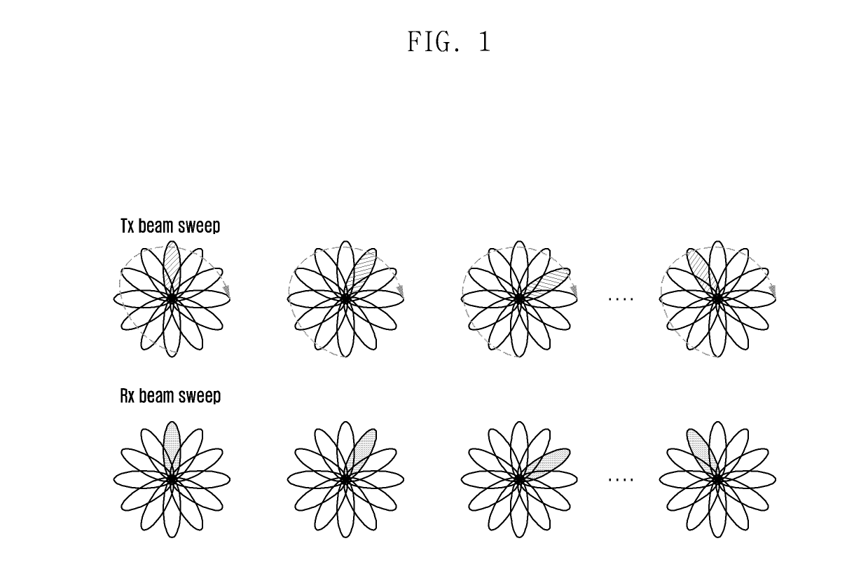

FIGS. 1 through 26, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The expressions such as “comprise” or “may comprise” that may be used in the present disclosure indicate the presence of the corresponding functions, operations, or components, etc., but do not limit at least one additional function, operation, or component, etc. Further, it will be further understood that the terms “comprises” or “have” used in the present disclosure, specify the presence of stated features, steps, operations, components, parts mentioned in this specification, or a combination thereof, but do not preclude the presence or addition of one or more other features, numerals, steps, operations, components, parts, or a combination thereof.

The expression such as “or” in the present disclosure includes any and all combinations of words listed together. For example, “A or B” may include A, include B, or include both of A and B.

The expressions such as “first,” “second,” “No. 1”, “No. 2,” etc. of the present disclosure can modify various elements of the present disclosure, but do not limit the corresponding constituent elements. For example, the expressions do not limit order and/or importance, or the like of the corresponding components. The expressions may be used to differentiate one component from other components. For example, both of a first user device and a second user device are user devices and represent different user devices. For example, a ‘first’ component may be named a ‘second’ component and the ‘second’ component may also be similarly named the ‘first’ component, without departing from the scope of the present disclosure.

It is to be understood that when one element is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without the other element intervening therebetween.

Terms used in the present disclosure are used only in order to describe specific exemplary embodiments rather than limiting the present disclosure. Singular forms are intended to include plural forms unless the context clearly indicates otherwise.

Unless being defined otherwise, it is to be understood that all the terms used in the present specification including technical and scientific terms have the same meanings as those that are generally understood by those skilled in the art. Terms generally used and defined by a dictionary should be interpreted as having the same meanings as meanings within a context of the related art and should not be interpreted as having ideal or excessively formal meanings unless being clearly defined otherwise in the present disclosure.

In the present specification, a radio air technology (RAT) named 5G is a new RAT for supporting high-capacity traffic and may include a RAT that can support higher QoS, such as high link capacity and short latency delay, among RATs supported by a multi-RAT capable terminal.

FIG. 1 is a diagram illustrating a beamforming operation in a high frequency band.

A wireless communication system includes a plurality of nodes (e.g., a base station and a plurality of terminals), and one node may search for a best beam for wireless communication with a counterpart node and configure a best beam for transmitting and receiving data with the corresponding beam. In order to find the best beam, a full beam sweep is performed on as many as the number of transmitted beams and received beams as illustrated in FIG. 1. A process of finding a best beam for the counter node is called beam searching.

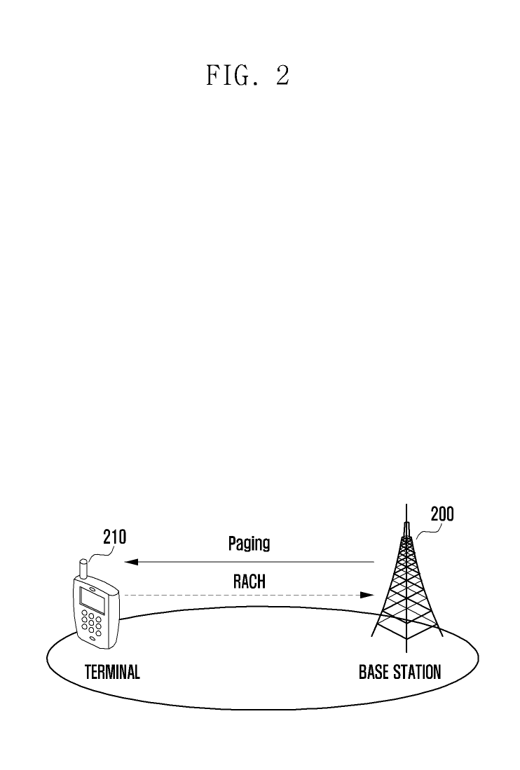

Referring to FIG. 2, a terminal 210 in a sleep mode may receive paging from a base station 200 and may transmit a random access channel (RACH) to the base station 200 in response to the received paging. Hereinafter, the terminal 210 enters a connection mode through a radio resource control (RRC) connection.

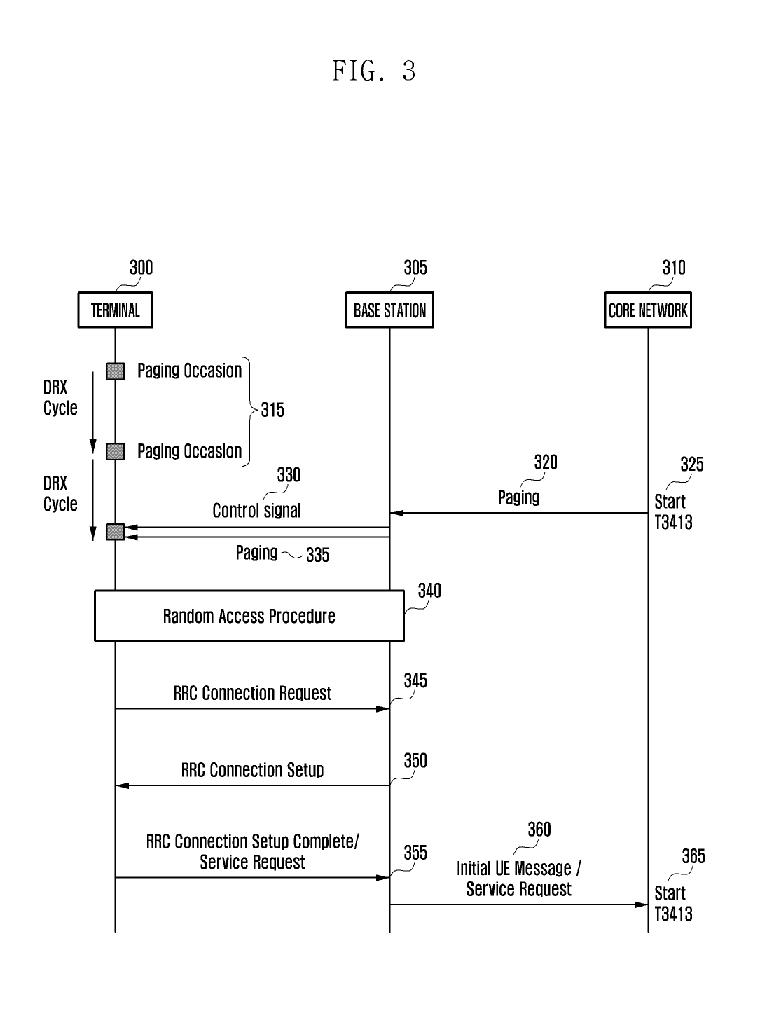

FIG. 3 is a diagram illustrating in more detail a paging-related operation in a wireless communication.

As in step 315, a terminal 300 may monitor a paging signal based on a discontinuous reception (DRX) period.

A core network 310 (e.g., mobility management entity (MME)) may transmit a paging message to a base station 305 in step 320 to page the terminal 300 in the sleep mode. Further, in step 325, the core network 310 may operate a timer (e.g., T3413).

In step 330, the base station 305 may transmit a control signal to the terminal 300. The control signal may include, for example, a common control signal and may be broadcast to all terminals within a cell. Further, in step 335, the base station 305 may transmit a paging message to the terminal based on the paging message received from the core network 310.

In step 340, the terminal 300 may perform a random access procedure with the base station 305. For example, the terminal 300 may transmit a random access preamble (RAP) to the base station 305 via the RACH. Further, the base station 305 receiving the random access preamble may transmit a random access response (RAR) to the terminal 300.

In step 345, the terminal 300 may transmit an RRC connection request message to the base station 305. In step 350, the base station 305 may transmit an RRC connection setup message to the terminal 300. In step 355, the terminal 300 may transmit an RRC connection setup complete message to the base station 305. In step 360, the base station 305 may transmit an initial terminal message to the core network 310, and the core network 310 receiving the initial terminal message may stop the already driven timer T3413 in step 365.

For example, the new RAT of the 5G performs an operation of supporting multiple services, such as URLLC, mMTC, and eMBB, which are supported in a low frequency and a high frequency band. Generally, since an omni-directional transmission is performed in the low frequency band, all of the data and the control signals may be transmitted to the full coverage within a cell by being transmitted once. However, if the beamforming transmission for ensuring coverage in a high frequency band is performed as illustrated in FIG. 1, a full beam sweep is performed on as many as the number of transmitted beams and received beams in order to transmit the control signal to all the cells.

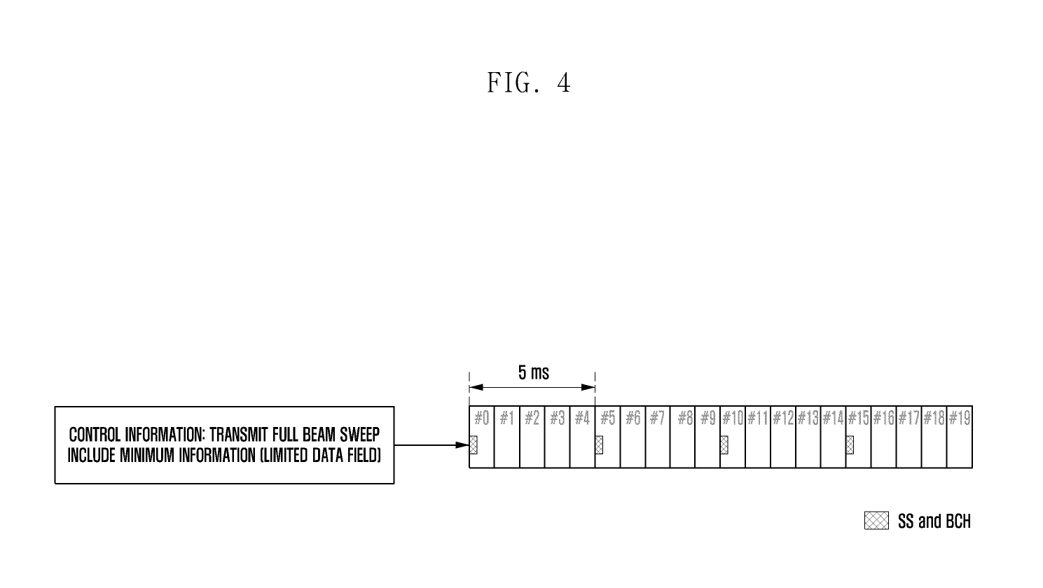

FIG. 4 illustrates an example of a frame structure design in a high frequency band beamforming transmission, and illustrates an example where the frame structure includes a PBCH that includes a synchronization signal (PSS/SSS) and minimum MIB information as control information. The control information is transmitted to all terminals within full cell coverage by a full beam sweep and then if information on the best beam is figured out, data may be transmitted by a dedicated beam.

Meanwhile, if the control information is transmitted in the high frequency band by the beamforming, transmission of all the control information by the full beam sweep may cause inefficiency in resource and power consumption. Accordingly, various embodiments of the present disclosure, a common control signal commonly applied to all terminals in the cell coverage is transmitted by the full beam sweep, and then if the best beam information for each terminal is figured out, a method for transmitting an on-demand control signal for each terminal by a dedicated beam is suggested.

In the wireless communication system using the beamforming, the base station may periodically transmit the common control signal. For example, the control signal may include system information (SI). Since the transmission of the entire SI by the full beam sweep has a huge control burden, it is useful to minimize a payload of the SI that is transmitted by the full beam sweep. That is, the SI information may be transmitted by being divided into two levels of minimum SI (i.e., common control signal) and other SI (i.e., on-demand control signal).

For example, the base station may perform an operation of transmitting the minimum SI and transmitting the other SI. The minimum SI is information that all terminals in the cell coverage have to receive and may be transmitted by the full beam sweep transmission/reception operation, including the minimum information. The other SI may be service-specific information and/or terminal-specific information and may be transmitted by a dedicated beam sweep transmission/reception operation.

For example, even if the terminal is a terminal (UE capability limitation) that fixedly performs limited services for a plurality of services such as URLLC, mMTC, and eMBB, or terminals that can service both services (UE capability) and a terminal (UE capability holding) that may serve all of a plurality of services, when the limited services are performed at this point in time, the terminal needs to receive the other SI information corresponding to the corresponding service. Therefore, the terminal may feedback the best beam through a terminal feedback after receiving the minimum SI transmitted by the full beam sweep. Further, after the terminal requests required system information by the terminal feedback, the terminal may receive the other SI information corresponding to the requested system information by the dedicated beam.

Meanwhile, the terminal may receive the paging from the base station in the idle operation in an idle operation to figure out whether downlink traffic arrives. In the beamforming transmission system, not only the system information but also the beamforming full sweep procedure used for transmitting and receiving the paging signal may be burdened on the system efficiency. Accordingly, various embodiments of the present disclosure propose various paging procedures that may improve the signal transmission and reception burden.

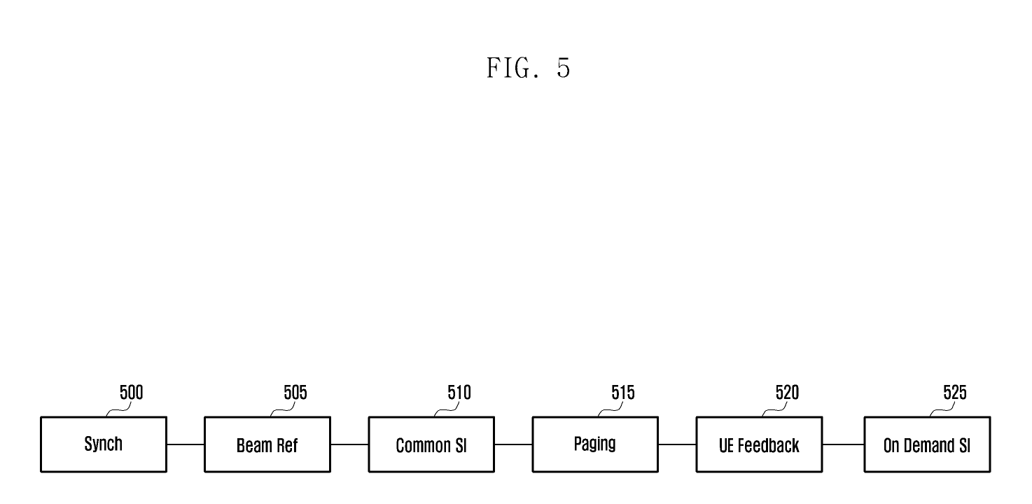

FIG. 5 is a diagram illustrating a paging operation based on a first paging option (full sweep paging) according to an embodiment of the present disclosure.

In step 500, the synchronization of the terminal is established based on the signal for synchronization establishment from the base station, and in step 505, beam refinement may be performed. Further, in step 510, the minimum SI may be transmitted and received between the base station and the terminal by the full beam sweep and in step 515, the paging may also be transmitted and received by the full beam sweep. The minimum SI and the paging may also be transmitted as a separate message or as a single message.

Hereinafter, in step 520, a paging target terminal may feedback the best beam information, the paging acknowledgment, and the terminal service related information through the terminal feedback. The terminal feedback may be sent and received by the dedicated beam based on the best beam. Hereinafter, in step 525, the other SI may be transmitted/received by the dedicated beam based on the best beam. At this point, the other SI may include the control information based on the fed back terminal service-related information. The other SI may be transmitted to the paging target terminal among terminals belonging to intra-cell coverage.

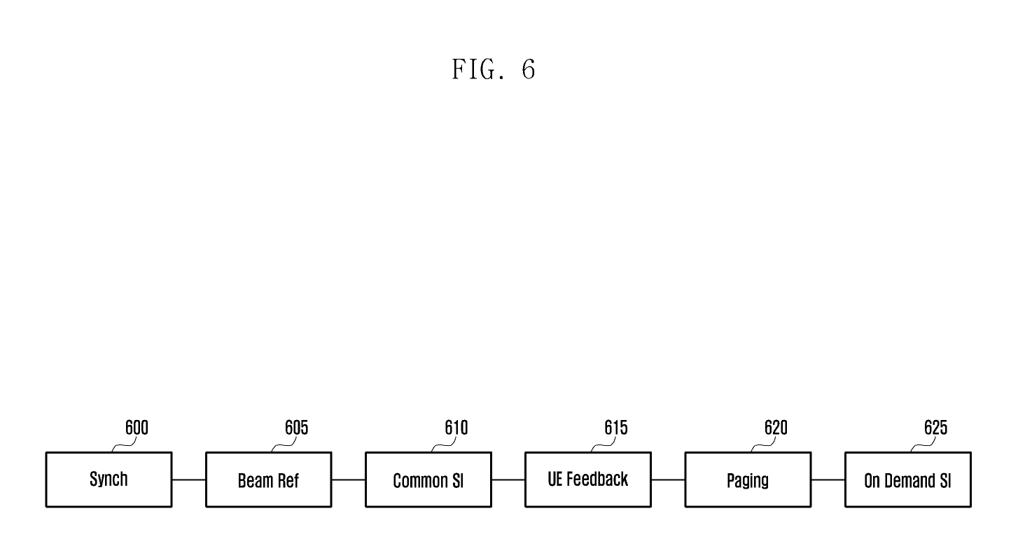

For example, the minimum SI may include information about a downlink bandwidth, SFN, scheduling information, and a paging option (first paging option and second paging option) indicator. The other SI includes service specific SI related to the eMBB, the URLLC, and the mMTC, and may include DRX configuration for each service/UE, RACH resource configuration, service request resource configuration (period), and the like. FIG. 6 is a diagram illustrating a paging operation based on a second paging option (dedicated paging) according to an embodiment of the present disclosure.

In step 600, the synchronization of the terminal is established based on the signal for synchronization establishment from the base station, and in step 605, the beam refinement may be performed. Further, in step 610, the minimum SI may be transmitted and received by the full beam sweep between the base station and the terminal.

Hereinafter, in step 615, all terminals that have received the minimum SI within the cell may feedback the best beam information, the UE service related information, and the like through the terminal feedback. The terminal feedback may be sent and received by the dedicated beam based on the best beam.

Hereinafter, in step 620, the paging may be transmitted and received by the dedicated beam based on the best beam. The paging may be transmitted to all the terminals belonging to the intra-cell coverage. Further, in step 625, the other SI may also be transmitted and received by the dedicated beam based on the best beam. At this point, the other SI may include the control information based on the fed back terminal service-related information. The other SI may be transmitted to the paging target terminal among the terminals belonging to the intra-cell coverage.

The following Table 1 arranges the operations of the terminal and the base station in the first and second paging options, respectively.

TABLE 1

| Operation order | 1 | 2 | 3 | 4 | 5 | 6 |
|---|---|---|---|---|---|---|
| Option 1 | Sync | Beam | Minimum | Paging | UE | On |
| (full sweep | | refine | SI | | feedback | demand SI |
| paging) | Full | Full | Full | Full | Dedicated | Dedicated |
| | sweep | sweep | sweep | sweep | beam | beam |
| Option 2 | Sync | Beam | Minimum | UE | Paging | On |
| (dedicated | | refine | SI | feedback | | demand SI |
| paging) | Full | Full | Full | Dedicated | Dedicated | Dedicated |
| | sweep | sweep | sweep | beam | beam | beam |

According to the embodiment of the present disclosure, the base station may determine whether it is desirable to operate according to which one of the first and second paging options. For example, the base station may start a paging option determination operation periodically or when a specific event occurs.

For example, the base station may determine the paging option based on information of at least one of whether a cell is in a dormant mode, the number of terminals within a cell, and a cell traffic load. The so determined paging option may be informed to the terminal and the terminal may perform a control information receiving and paging operation depending on the corresponding paging option. For example, paging option determination information may be included in the minimum SI and broadcasted to terminals.

The operation according to the first paging option according to the embodiment of the present disclosure has a burden to perform the paging transmission by the full beam sweep. Therefore, the lower the traffic load in the cell, the lower the paging transmission frequency is advantageous.

On the other hand, the operation according to the second paging option according to the embodiment of the present disclosure has the burden that all terminals within the cell coverage should send the terminal feedback. Therefore, if the cell is in the dormant mode, the smaller the number of terminals within the cell is advantageous.

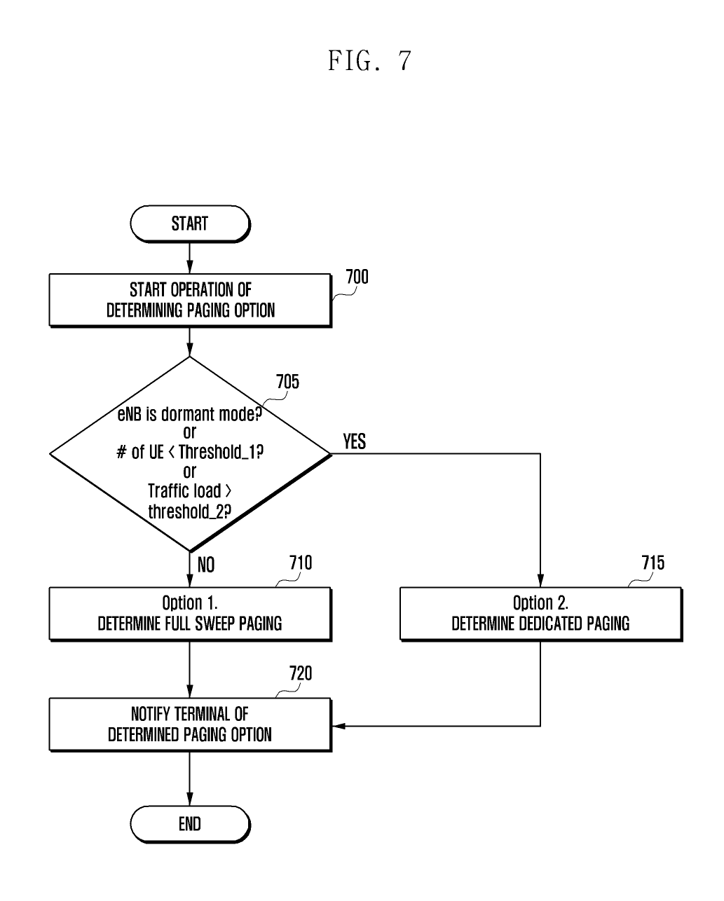

FIG. 7 is a flow chart illustrating a paging option determination operation of a base station according to an embodiment of the present disclosure.

In step 700, the base station may start the operation for determining a paging option. The base station may perform the paging option determination operation periodically or when a specific event occurs.

For example, the base station may trigger the paging option determination when at least one of various parameters is changed over a predetermined range.
A parameter indicating whether the cell is in the dormant mode
Parameters related to the number of terminals within the cell
Cell traffic load related parameters

In step 705, the base station may determine the paging option by considering at least one of whether the cell is in the dormant mode, the number of terminals within the cell, and the traffic load.

In step 710, the base station may determine the paging option as the first paging option if the cell is not in the dormant mode, if the number of terminals within the cell is over a predetermined value, or if the cell traffic load is below a predetermined value.

On the other hand, in step 715, the base station may determine the paging option as the second paging option if the cell is in the dormant mode, if the number of terminals within the cell is below a predetermined value, or if the cell traffic load is over a predetermined value.

In step 720, the base station may notify the terminal of the determined paging option. For example, the base station may broadcast the paging option information by including the paging option information in the minimum SI. For example, the base station may transmit the paging option information (e.g., indicator) by including the paging option information in the minimum SI field, in addition to the downlink bandwidth related information, the SFN, the scheduling information, and the like.

The base station may perform the control information and paging transmitting operation based on the determined paging option information. Further, the terminal may perform the control information and paging receiving operation based on the paging option information received from the base station.

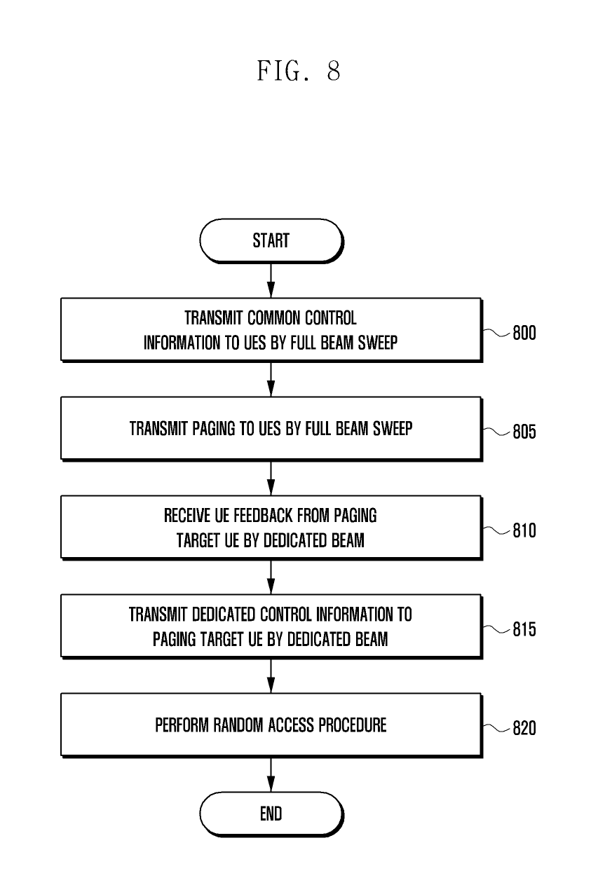

FIG. 8 is a diagram illustrating the operation of the base station in the first paging option (i.e., full sweep paging) according to the embodiment of the present disclosure.

If the first paging option is determined, in step 800, the base station may transmit the common control information to the terminals in the cell coverage by the full beam sweep.

In step 805, the base station may transmit the paging to the terminals within the cell coverage by the full beam sweep.

In step 810, the base station may receive the terminal feedback from the paging target terminal among the terminals in the cell coverage by the dedicated beam. At this time, it is possible to save power by the switching to the sleep mode without performing a terminal follow-up operation other than the paging target terminal.

In step 815, the base station may transmit the on-demand control information to the paging target terminal by the dedicated beam.

In step 820, the base station may perform the random access procedure with the terminal.

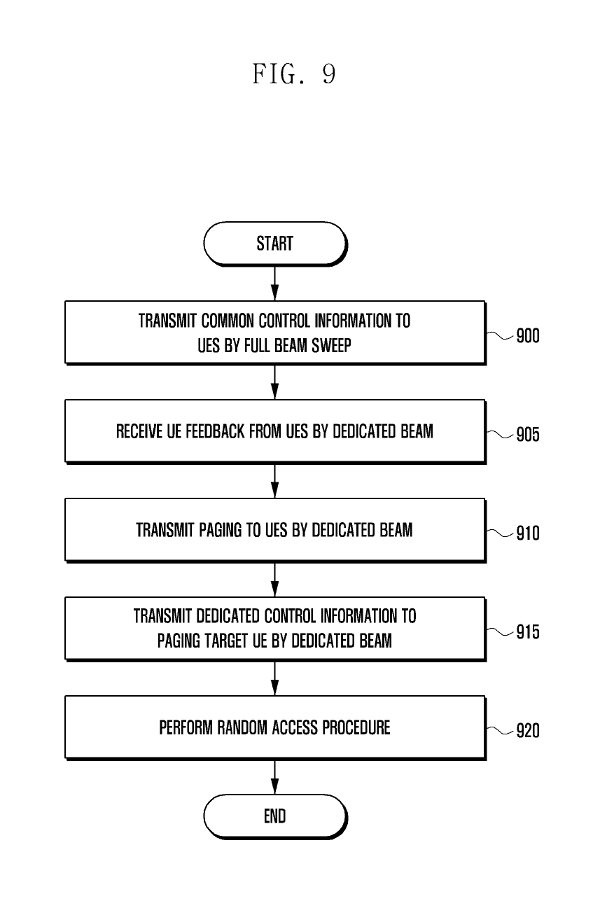

FIG. 9 is a diagram illustrating the operation of the base station in the second paging option (i.e., dedicated paging) according to the embodiment of the present disclosure.

If the second paging option is determined, in step 900, the base station may transmit the common control information to the terminals in the cell coverage by the full beam sweep.

In step 905, the base station may receive the terminal feedback from the terminals in the cell coverage by the dedicated beam.

In step 910, the base station may transmit the paging to the terminals within the cell coverage by the dedicated beam. Since the paging is transmitted by the dedicated beam, it is possible to reduce the paging transmission load and increase the power efficiency.

In step 915, the base station may transmit the on-demand control information to the paging target terminal by the dedicated beam.

In step 920, the base station may perform the random access procedure with the terminal.

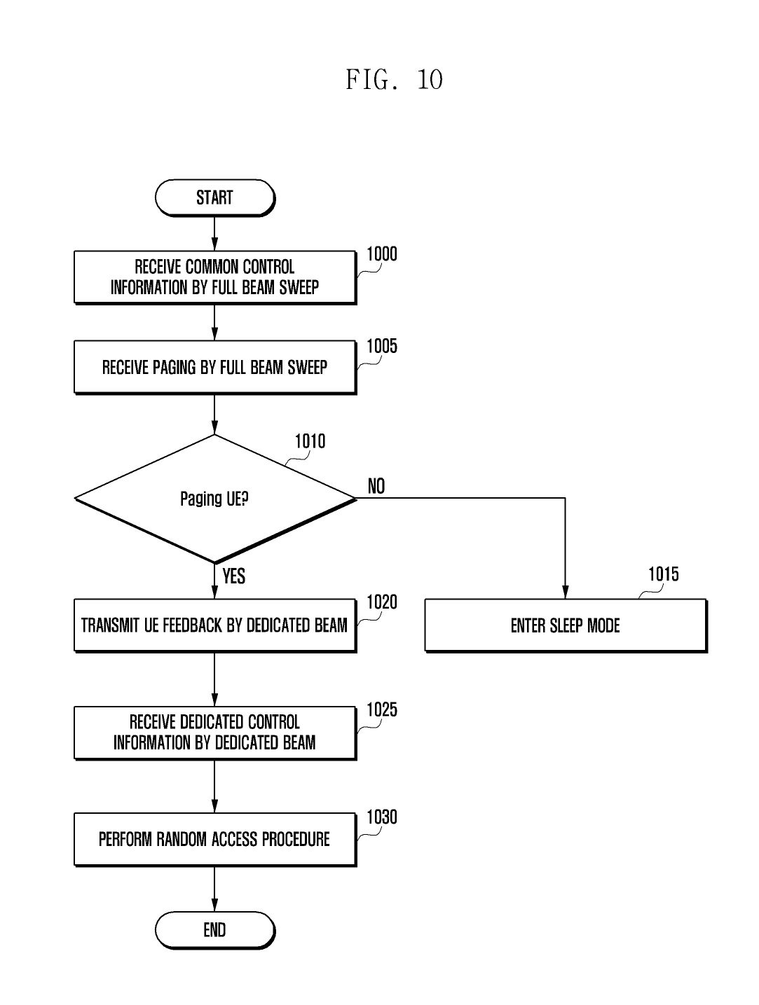

FIG. 10 is a diagram illustrating the operation of the terminal in the first paging option according to the embodiment of the present disclosure.

If the information indicating that the paging option is determined as the first paging option is received from the base station, in step 1000, the terminal may receive the common control information from the base station by the full beam sweep. Further, in step 1005, the terminal may receive the common control information from the base station by the full beam sweep.

In step 1010, the terminal may determine whether it is the paging target terminal based on the received paging signal and its identification information. If the terminal is not the paging target terminal, in step 1015, the terminal can enter the sleep mode.

If the terminal is the paging target terminal, in step 1020, the terminal may send the terminal feedback to the base station by the dedicated beam.

Further, in step 1025, the terminal may receive the on-demand control information from the base station by the dedicated beam.

In step 1030, the terminal may perform the random access procedure with the base station.

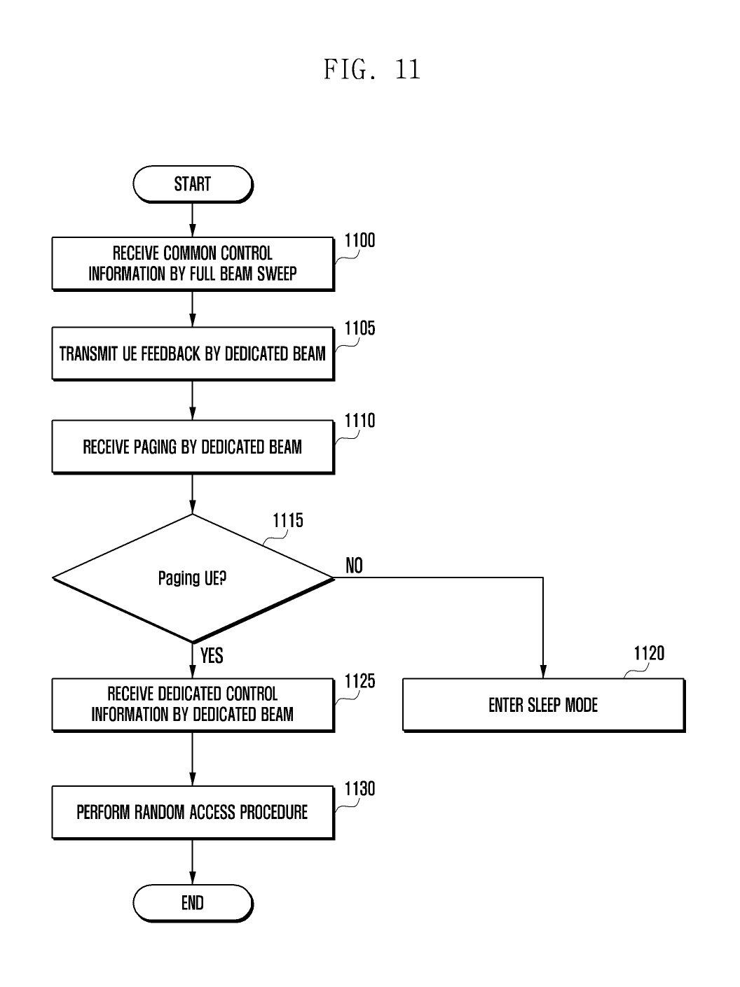

FIG. 11 is a diagram illustrating the operation of the terminal in the second paging option according to the embodiment of the present disclosure.

If the information indicating that the paging option is determined as the second paging option is received from the base station, in step 1100, the terminal may receive the common control information from the base station by the full beam sweep.

In step 1105, the terminal may send the terminal feedback to the base station by the dedicated beam.

Thereafter, in step 1110, the terminal may receive the paging from the base station by the dedicated beam.

In step 1115, the terminal receiving the paging may determine whether it is the paging target terminal based on the received paging signal and its identification information. If the terminal is not the paging target terminal, in step 1120, the terminal can enter the sleep mode.

If the terminal is the paging target terminal, in step 1125, the terminal may receive the on-demand control information from the base station by the dedicated beam.

In step 1130, the terminal may perform the random access procedure with the base station.

Meanwhile, the second paging option operation according to the embodiment of the present disclosure may be usefully used in terminal initiated paging (PSM mode) situations. Further, the terminal feedback of the terminal may be made by a non-orthogonal multiple access (NOMA)-based transmission. A terminal feedback transmission period and related field may be configured based on service traffic patterns and QoS levels for each service such as mMTC, URLLC, and eMBB. If the terminal feedback is small data, it may be sent by simple signaling.

Further, the idle mode operation may be performed in consideration of a UE mobility level. The location information to be included in the terminal feedback may be determined differently depending on the UE mobility level (e.g. moving speed: stop, low speed, high speed).

For example, a location information level of a high-speed moving terminal may be set to be a cell ID, a paging area ID (PAID), or a tracking area ID (TAID). The paging area ID (PAID) means an ID of an area in which the same paging is performed on a plurality of cell groups. The tracking area ID (TAID) means an ID of a cell group belonging to a tracking list when the UE mobility is supported.

On the other hand, the location information level of the low-speed moving terminal may be set to be a beam ID, a transmissions/receptions point (TRP) ID, or a transmissions/receptions point group (TRPG) ID. The transmissions/receptions point (TRP) ID refers to an ID of a transmitted and received portion where physical data transmission/reception is made when the base station is implemented by being separated into a control unit (CU) function and a radio unit (RU) function. One CU may consist of a plurality of TRPs, and it is configuration issue whether a cell may be viewed as one TRP or defined as a plurality of TRP groups. The location information of the terminal may be figured out based on the IDs of the TRP and the TRPG. Meanwhile, if the paging operation is performed depending on the first paging option, there is a burden of the transmission of the paging message to all the terminals within the cell coverage by the full beam sweep. Hereinafter, a method for improving transmission resources and power efficiency based on a two-step paging operation of extracting some of information within the existing paging message is suggested.

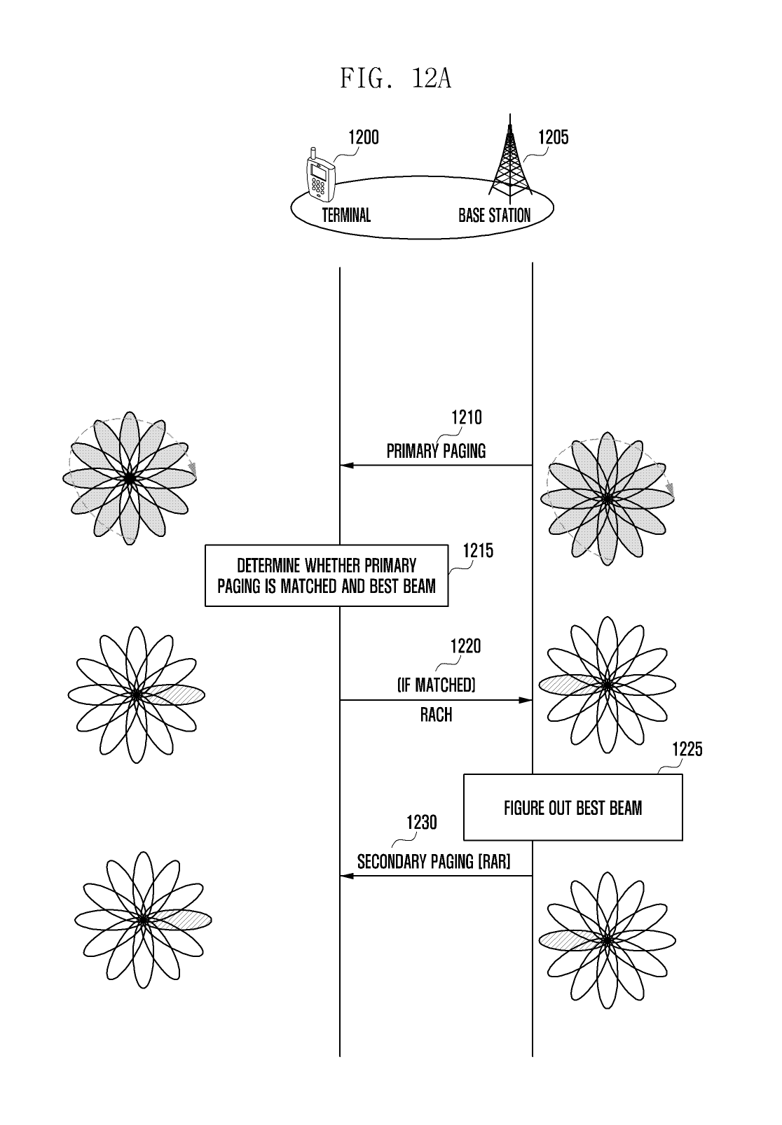

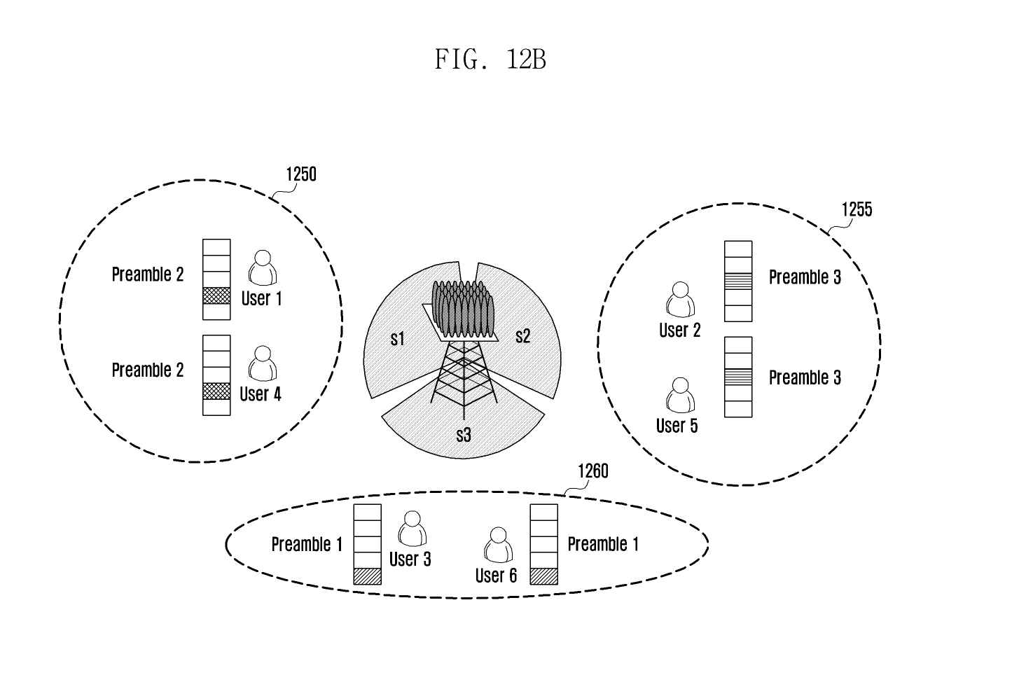

FIG. 12A is a diagram illustrating an operation according to a multiple-step paging signal transmission in the first paging option according to the embodiment of the present disclosure.

According to the embodiment of the present disclosure, the base station may limit a group of paging target terminals through a one-step paging signal transmission and may complete a paging operation for the paging target terminal through the 2-step paging signal transmission for at least one terminal within the terminal group.

In step 1210, a base station 1205 may transmit primary paging to a terminal 1200 in a sleep mode by the full beam sweep. The primary paging is to specify a terminal to be paged. For example, the primary paging may include a part (e.g., MSB, LSB, etc.) of an identifier of a terminal or paging indicator group information. The base station may determine the best beam of the base station based on the primary paging transmission.

In step 1215, the terminal 1200 may receive the first paging by the full beam sweep to determine the best beam. Further, the terminal 1200 may determine whether it matches the primary paging to perform a primary limitation on the paging target. For example, if the primary paging includes a part of the identifier of the terminal (for example, X bit), it may be determined whether or not the stored identifier of the terminal includes ID parsing information included in the primary paging to determine whether the terminal 1200 matches the primary paging. If the primary paging includes paging identification group information, it may be determined whether the terminal 1200 matches the primary paging by determining whether the primary paging belongs to the corresponding group. At this time, the terminal 1200 may store information corresponding to the corresponding paging identification group information.

If it is determined that the terminal 1200 matches the primary paging, in step 1220, the terminal 1200 may send the terminal feedback to the base station 1205 by the dedicated beam based on the best beam. At this time, the terminal feedback transmission may include the performance of the RACH of the terminal. For example, the terminal feedback (e.g., RACH) may include the best beam information of the terminal and inform it to the base station 1205. Further, the terminal feedback (e.g., RACH) may include a part (e.g., Y bit, which may exclude information included in the primary paging as one example) of the identifier of the terminal. A part (e.g., Y bit) of the identifier of the terminal may be transmitted by a data payload or may be transmitted while being mapped to a RACH preamble sequence upon the RACH.

In step 1225, the base station 1205 may receive the terminal feedback to figure out the best beam information of the terminal. Further, the base station 1205 may perform a secondary limitation by comparing a part of the terminal ID included in the terminal feedback with an identifier of the paging target terminal. If the identifier of the paging target terminal is a part of the terminal ID included in the terminal feedback, it may be determined that the corresponding terminal is included in a secondary limitation target.

In step 1230, the base station 1205 may transmit secondary paging to the terminal 1200 of the secondary limitation target by the dedicated beam based on the best beam. The secondary phasing may include, for example, RAR. The secondary paging may specify a final paging target terminal, including, for example, the remaining part (e.g., Z bit, which may exclude information included in the secondary paging and the terminal feedback as an example) of the identifier of the terminal.

The terminal 1200 receiving the secondary paging finally confirms whether the terminal 1200 is the paging target terminal and if it is confirmed whether the terminal 1200 is the paging target terminal, the terminal 1200 may perform the RRC connection operation to enter a connected mode.

In the multiple-step paging signal transmission as described above, in the case where the identifier of the terminal is W bit, the information included in the primary paging is X bit, and the information included in the terminal feedback is Y bit, if W<X+Y, it is possible to figure out the best beam of the paging target terminal in the secondary paging and the base station may transmit the final paging to the corresponding terminal by the dedicated beam.

If W>X+Y, the base station should transmit the secondary paging to a plurality of terminals in order to determine the remaining Z bit (W-X-Y bit) in the identifier of the paging target terminal. At this time, the base station may notify the Z bit (W-X-Y bit) information by transmitting the RAR to the limited terminal groups based on the terminal feedback information to determine the final paging target terminal. At this time, the terminal that does not receive the PAR is not operated by the existing legacy RACH but may be configured not to perform an RACH retransmission (power ramping up) operation without the RAR according to the multiple-step paging signal transmission operation according to the embodiment of the present disclosure.

FIG. 12B is a diagram illustrating an embodiment for performing a paging operation based on terminal grouping depending on the best beam.

For example, in FIG. 12A, when terminals transmit the terminal feedback information (step 1220), the terminal grouping is performed based on the best beam of the base station, such that the best beams may send the terminal feedback information by mapping the same terminals to the same group.

Further, when the base station transmits the secondary paging to the limited terminal based on the terminal feedback information (e.g., 1230), the terminal grouping is performed based on the best beam of the base station, such that the best beam may transmit the secondary paging by the dedicated beam by mapping the same terminals to the same group.

For example, in each of 1250, 1255, and 1260, the best beam of the base station divides and groups the same terminals. As described above, the terminal feedback information transmission and/or the secondary page transmission may be performed for each group. Meanwhile, an example of an RRC new field parameter for supporting the multiple-step paging signal transmission operation is as follows. The following paging indicator means the primary paging.
Whether the paging indicator is operated (0 or 1)
Paging indicator rules (LBS, MSB, etc)
The number of paging indicator bits (X bit)

| | |
|---|---|
| Paging-Config ::= | SEQUENCE { |

paging_IndicatorENUMERATED {0,1}
paging_Indicator_ruleENUMERATED {lbs, msb, reserv1,reserv2}

| | |
|---|---|
| bits_paging_indicator | ENUMERATED {0, 1, 2,. . , full_bit} |

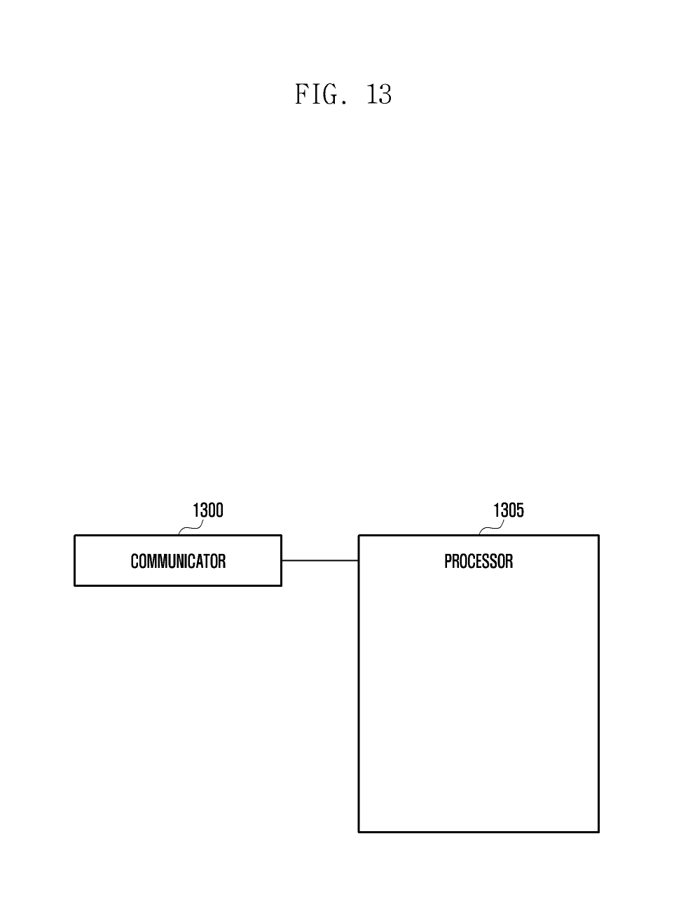

FIG. 13 is a block diagram schematically illustrating a configuration of a base station according to an embodiment of the present disclosure.

The base station may include a communicator 1300 and at least one processor 1305.

The communicator 1300 is electrically connected to the processor 1305 and may transmit and receive a signal to/from an external device (e.g., a terminal) by a control of the processor 1305.

The processor 1305 may control the operation of the base station according to various embodiments of the present disclosure. For example, the processor 1305 may control the operation of the base station according to FIGS. 7 to 9 and FIG. 12.

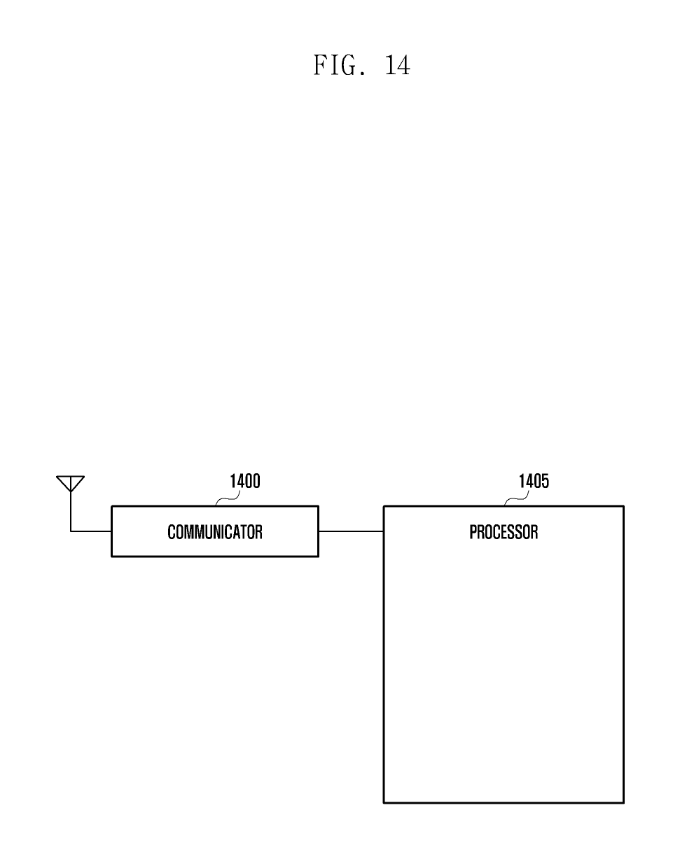

FIG. 14 is a block diagram schematically illustrating a configuration of a terminal according to an embodiment of the present disclosure.

The terminal may include a communicator 1400 and at least one processor 1405.

The communicator 1400 is electrically connected to the processor 1405 and may transmit and receive a signal to/from an external device (e.g., a terminal) by a control of the processor 1405.

The processor 1405 may control the operation of the base station according to various embodiments of the present disclosure. For example, the processor 1405 may control the operation of the terminal according to FIGS. 7 to 10 and FIG. 12.

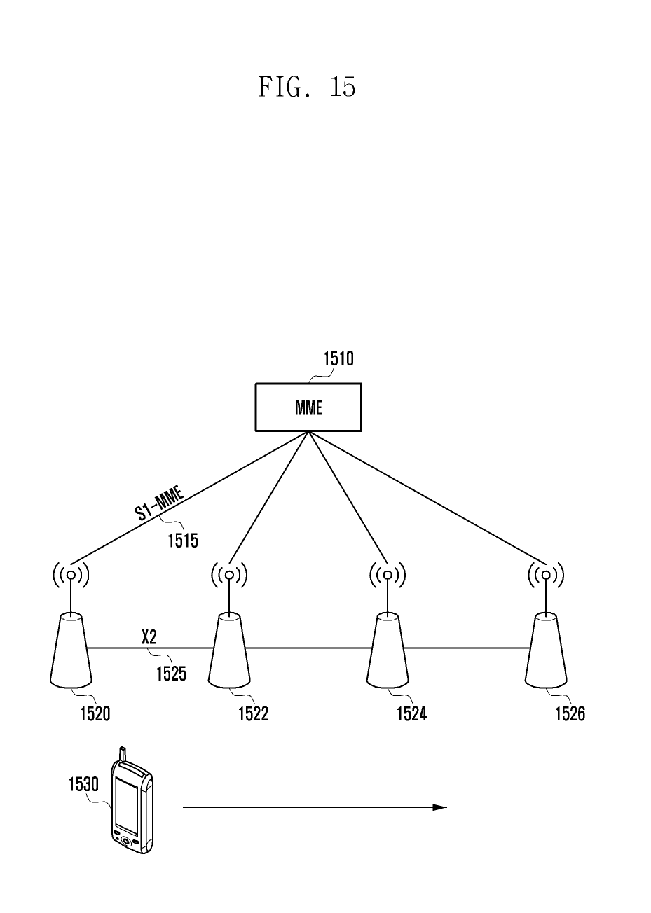

FIG. 15 is a diagram illustrating a movement of a terminal of a mobile communication system.

Referring to FIG. 15, a terminal 1530 may perform a location movement in a communication system including a mobility management entity (MME) 1510 and base stations 1520, 1522, 1524, and 1526. The MME 1510 and the base stations 1520, 1522, 1524 and 1526 may be connected to each other by an S1-MME 1515 interface and the base stations 1520, 1522, 1524 and 1526 may be connected to each other by an X2 1525 interface. The communication network may further include entities not illustrated in the drawings other than the above components. In the case of the mobility management of the terminal 1530 such as the configuration illustrated in the drawings, high mobility may be supported.

The terminal 1530 may move an area covered by each of the base stations 1520, 1522, 1524, and 1526 in an idle state or a connected state and may perform signaling on the network for the movement management of the terminal 1530. Tracking area update (TAU) may be performed when the network moves in the idle state, and handover may be performed when the network moves in the connected state.

Further, in the embodiment of the present specification, a suspend state may be additionally defined. In this case, the terminal 1530 is not in the RRC connected state with the base station, but the base station stores context information related to the terminal 1530 and if the terminal 1530 again accesses the base station in the suspend state, may a signal to the terminal using the stored context. Meanwhile, in the embodiment, the base station may determine the time for maintaining the context information of the terminal 1530, and may delete the context information or transmit the context information to another base station if the terminal is not connected for a specific time.

Meanwhile, in the idle state, the following operations may be performed:
Public land mobile network (PLMN) selection performance
Performance of discontinuous reception setup through a non access stratum (NAS)
Performance of broadcast of system information
Paging message transmission/reception
Mobile related cell re-selection
Assignment of identifier that may identify terminal on tracking area
Deletion of RRC context information related to the terminal on the base station
Sidelink communication transmission/reception for D2D communication, or the like
Transmission and monitoring of a sidelink discovery signal for D2D communication, or the like

Further, in the connected state, the following operations may be performed:
RRC connection between terminal and base station
Store the RRC context information of the terminal on the base station
The base station figures out network information to which the terminal belongs
The network may transmit and receive data to and from the terminal
The network may perform handover in association with the mobility of the terminal
Monitoring adjacent cells
Sidelink communication transmission/reception for D2D communication, or the like
Transmission and monitoring of a sidelink discovery signal for D2D communication, or the like

The transition from the connected state to the idle state may be performed based on an RRC connection release message transmitted from the base station to the terminal, and the state transition from the idle state to the connected state may be performed through the access operation of the following embodiment.

Further, in order for the MME to manage the state of the UE, it is useful to consider the mobility of the UE. The terminal may perform the operation of monitoring the paging signal after the discontinuous reception (DRX) period in order to receive the signal transmitted by the base station, such that the terminal may receive the signal transmitted by the base station and the MME may perform the state transition of the terminal.

For the state transition of the terminal, the area of the network that transmits the paging is called a tracking area (TA), in which the TA may target one base station or a bundle of base stations.

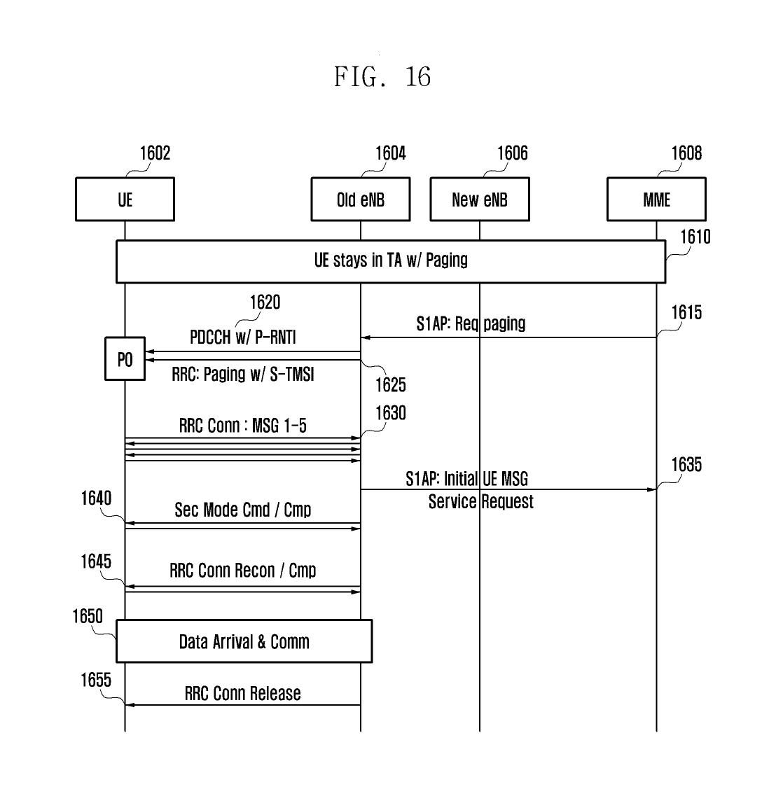

FIG. 16 is a diagram illustrating a terminal management method using a tracking area (TA) in the mobile communication system.

Referring to FIG. 16, a terminal 1602 is staying in an area of an old base station 1604 and may move to a new base station 1606. In addition, MME 1608 may transmit and receive a signal for managing the mobility of the terminal.

In operations below step 1610, a procedure for a terminal to receive a paging signal while staying in TA will be described.

In step 1615, the MME may transmit a paging request message to the old base station 1604 via an S1AP message. The paging request message may include the identifier of the terminal.

In step 1620, the old base station 1604 may transmit a physical downlink control channel (PDCCH) including P-RNTI to the terminal 1602.

In addition, in step 1625, the old base station 1604 may transmit a paging message including S-TMSI to the terminal 1602. In the embodiment, the operations of steps 1615 and 1620 may be performed selectively or sequentially, and the operation may be performed in a period of paging occasion (PO).

In step 1630, the terminal 1602 and the old base station 1604 may exchange messages 1 to 5 for the connection with each other, and in step 1635, the old base station 1604 may transmit a service request message to the MME 1608. In the embodiment, the service request message may be an initial terminal message.

In step 1640, the terminal 1602 may exchange command and response messages related to security mode with the old base station 1604, and in step 1645, may exchange an RRC connection reconfiguration message and an RRC connection reconfiguration complete message.

Hereinafter, in step 1650, the terminal 1602 may transmit and receive data to and from the old base station 1604. Next, in step 1655, if the terminal 1602 releases the connection, the old base station 1604 may transmit an RRC connection release message to the terminal.

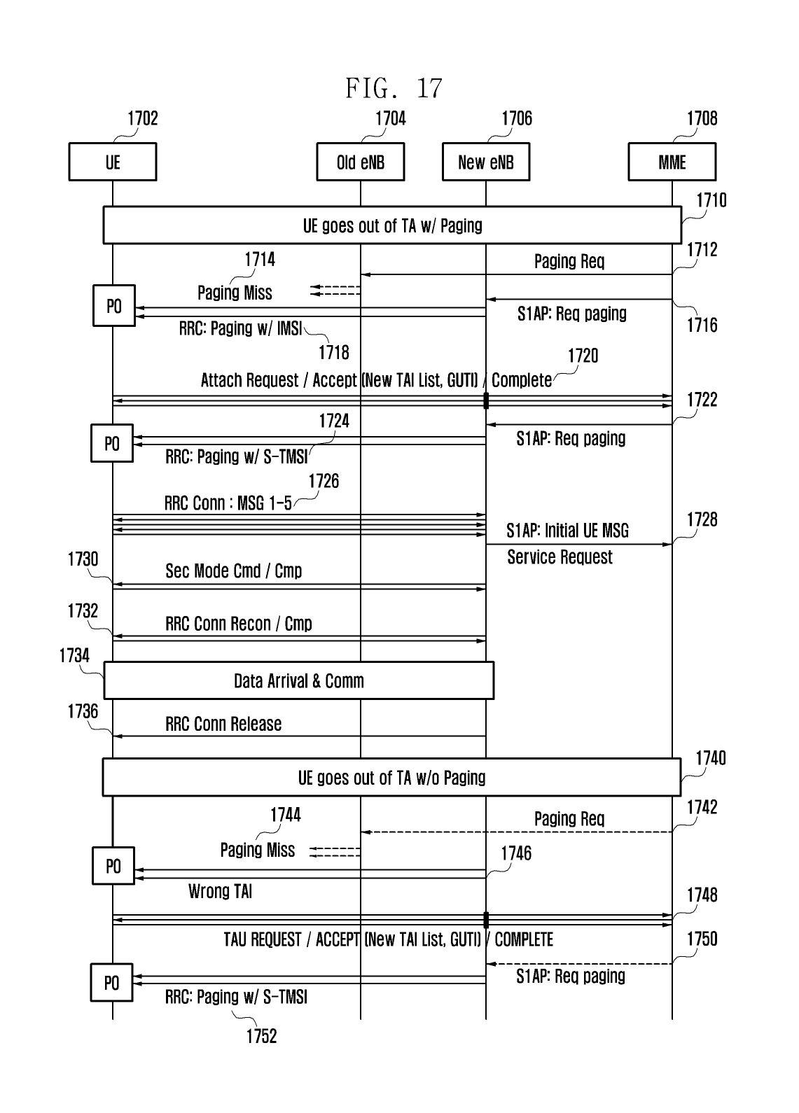

FIG. 17 is a diagram illustrating another terminal management method using the TA in the mobile communication system.

Referring to FIG. 17, a terminal 1702 is staying in an area of an old base station 1704 and may move to a new base station 1706. In addition, MME 1708 may transmit and receive a signal for managing the mobility of the terminal.

In operations below step 1710, if the terminal is out of the TA, an operation related to the case where the terminal transmits the paging message will be described.

In the embodiment, the old base station 1704 and the new base station 1706 may be base stations located in different TAs.

In step 1712, the MME 1708 may transmit a paging request to the old base station 1704, and since the terminal 1702 is out of the old base station 1704, the paging message may not be transmitted to the terminal in step 1714.

In step 1716, the MME 1708 may transmit the paging request message to the new base station 1706 via the S1AP message. The paging request message may include an identifier of the terminal 1702.

In addition, in step 1718, the new base station 1706 may transmit the paging message including the S-TMSI to the terminal 1702.

In step 1720, an attach-related operation may be performed between the terminal 1702, the new base station 1706, and the MME 1708, and a new TAI list and a GUTI may be assigned. Hereinafter, the terminal 1702 may be switched to the idle state again.

Hereinafter, in step 1722, the MME 1708 may again transmit the paging request message to the new base station 1706 via the S1AP message. The paging request message may include the identifier of the terminal 1702.

In addition, in step 1724, the new base station 1706 may transmit the paging message including the S-TMSI to the terminal 1702.

In step 1726, the terminal 1702 and the old base station 1706 may exchange the messages 1 to 5 for the connection with each other, and in step 1728, the new base station 1706 may transmit the service request message to the MME 1708 based thereon. In the embodiment, the service request message may be the initial terminal message.

In step 1730, the terminal 1702 may exchange the command and response messages related to the security mode with the old base station 1706, and in step 1732, may exchange the RRC connection reconfiguration message and the RRC connection reconfiguration complete message.

Hereinafter, in step 1734, the terminal 1702 may transmit and receive data to and from the new base station 1706. Next, in step 1736, if the terminal 1706 releases the connection, the new base station 1706 may transmit an RRC connection release message to the terminal, such that the terminal 1702 may be switched to the idle state.

In operations below step 1740, the embodiment of the case where the terminal is out of the TA without the paging message will be described.

In step 1742, the MME 1708 may request the paging request to the old base station 1704, and thus in step 1744, the old base station 1704 may transmit the paging message but since the terminal 1702 is out of the TA corresponding to the old base station 1704, the paging message may not be transmitted. In the embodiment, steps 1742 and 1744 may optionally be performed.

In step 1746, the new base station 1706 may transmit the paging message, but since a TA identifier (TAI) is different and there the terminal 1702 may not receive the paging message.

In step 1748, the terminal 1702 may transmit a TA update (TAU) request message to the MME 1708 via the new base station 1706 and receive an accept message for the TAU update request message. The TAU accept message may include at least one of a new TAI list and the GUTI. By the above procedure, the TAU may be completed and the terminal 1702 can send a complete message to the MME 1708.

In step 1750, the MME 1708 may transmit the paging request message to the new base station 1706, and in step 1752, the new base station 1706 may transmit the paging message including the S-TMSI to the terminal 1702 and then the terminal 1702 may perform a connection forming procedure with the new base station 1706.

Also, in the embodiment, since the TA has a value set by the MME, if the terminal is out of the corresponding TA range due to the mobility of the UE, the terminal may request the corresponding TA update to the MME. The operation for determining the corresponding situation may be performed by a method for comparing with a TA set based on tracking area identity (TAI) information included in system information (SI) by the terminal.

In the embodiment, if the RRC release is performed, the base station may delete the terminal context information related to the terminal, but in another embodiment, it is possible to consider a method for maintaining the terminal context without deleting the terminal context even when a sub state is not connected to the RRC connected. More specifically, in the embodiment, instead of the RRC release, a message indicating the RRC suspend state may be transmitted to the terminal. In this case, the connection may be resumed by transmitting an RRC resume message instead of a separate paging message. In this case, it is possible to omit a separate signal exchange procedure for acquiring the terminal context information by using the maintained terminal context information as it is.

Further, in the embodiment, if the base station transmits a signal to the terminal, it may transmit the signal in consideration of a frequency domain, a time domain, and a spatial domain. In addition, if at least one of the base station and the terminal uses a plurality of antennas, a beam may be formed. In this case, a signal may be transmitted to the terminal by newly considering the beam domain. At this time, at least one of analog beamforming and digital beamforming may be applied to the beam, and even when the same frequency and the same time resource are used, different beams are formed so that the base station may transmit dedicate information to different terminals. By using the multiple domains, it is possible to more easily use the enhanced mobile broadband (eMBB), the ultra reliable low latency (URLL), massive machine type communication (mMTC) or other types of services (network slice ID, RAN slice ID, application ID). Further, it is possible to more easily manage the mobility of the terminal, and smoothly provide services such as traffic activity, vehicle to anything (V2X), and device to device (D2D).

If the beam domain is used as described above, it is useful to efficiently provide the beam information to a user, and it is useful to decrease a beam sweeping load. Further, it is useful to efficiently set a paging area (PA) corresponding to the TA if the paging is transmitted to the user using the beam domain, efficiently control the RRC state of the terminal, and set conditions for the transition between the respective states.

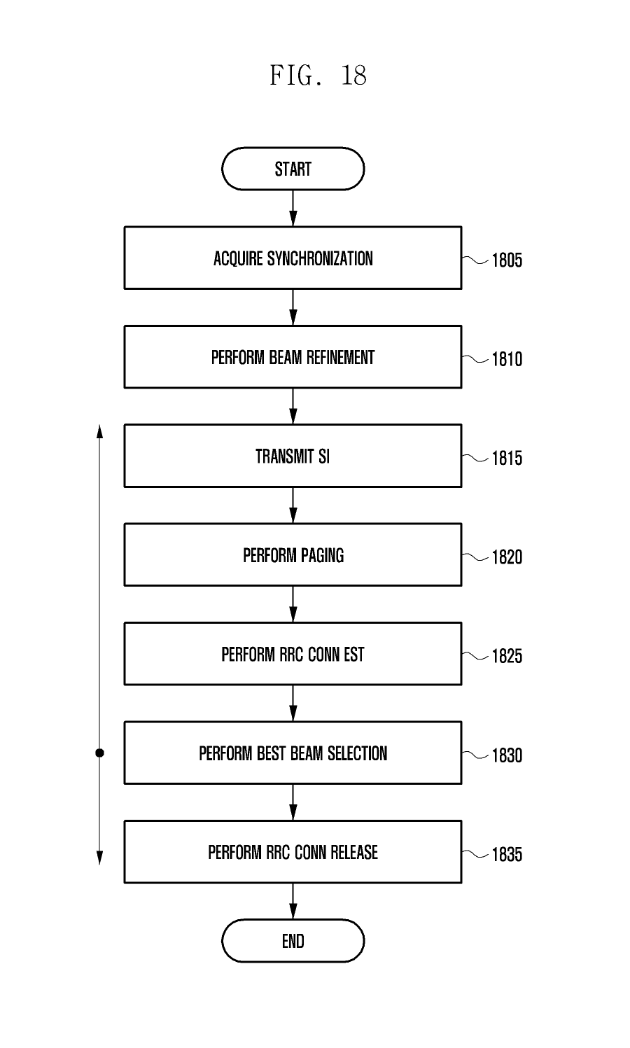

FIG. 18 is a diagram illustrating a method for connecting and disconnecting a terminal to a communication system.

Referring to FIG. 18, the terminal and the base station acquire synchronization, and may transmit/receive a signal based on the synchronization. In the embodiment, the terminal may establish the connection with the base station and thus may transmit and receive information. In the embodiment, the order of the operations may be variably changed.

In step 1805, the terminal may acquire synchronization from the base station. More specifically, a primary synchronization signal (PSS) and a secondary synchronization signal (SSS) may be received from the base station, such that radio frame and subframe synchronization may be acquired from the base station. Further, in the embodiment, it is also possible to receive an additional synchronization signal. The additional synchronization signal may be an extended synchronization signal (ESS), and the synchronizing signal may include the beam information. The beam information may include beam ID information.

In step 1810, the terminal may acquire detailed beam information from the base station and perform beam performance refinement based thereon. More specifically, the base station may transmit a signal for beam refinement to the terminal, and the terminal may measure signal quality for each beam based on the signal. In the embodiment, the beam refinement signal may include at least one of a beam refinement signal (BRS) and a beam refinement reference signal (BRRS), and the beam refinement signal may be transmitted in all subframes or in a subframe determined by the preset rules. The preset rule may be transmitted to the terminal by higher signaling including the system information and the RRC signaling.

In step 1815, the terminal may receive the system information (SI) from the base station that acquires synchronization. The system information may be transmitted in a broadcast type so that it may be received by all terminals within the cell related to the base station. In addition, the system information may include information for transmitting and receiving signals between the terminal and the base station, and may receive information that includes master information block (MIB), downlink bandwidth or paging assistance information (cell ID, TRP ID, etc.), paging indication information (whether paging for each paging group arrives), and the like.

In step 1820, the terminal may receive the paging information from the base station, and in step 1825, the terminal may establish the RRC connection with the base station based on the paging information.

In step 1830, the terminal may acquire the best beam information through the signal exchange with the base station. Acquiring the best beam information may be performed based on reference signal reception quality or the like, and if the best beam information is changed, the terminal and the base station may perform an operation of exchanging information thereon and changing the beam to be used.

In step 1835, the base station may transmit the RRC connection release message to the terminal to release the connection. In the embodiment, the base station may also maintain the terminal context by transmitting an RRC connection suspend message without performing the connection release.

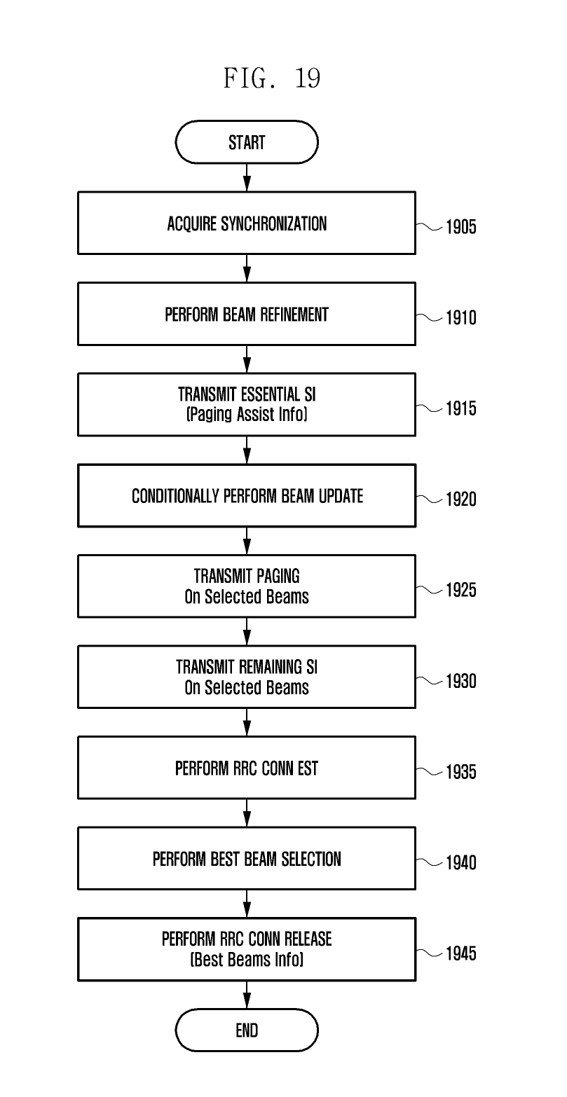

FIG. 19 is a diagram illustrating another method for connecting and disconnecting a terminal to a communication system.

Referring to FIG. 19, the terminal and the base station acquire synchronization, and may transmit/receive a signal based on the synchronization. In the embodiment, the terminal may establish the connection with the base station and thus may transmit and receive information. In the embodiment, the order of the operations may be variably changed.

In step 1905, the terminal may acquire the synchronization from the base station. More specifically, the primary synchronization signal (PSS) and the secondary synchronization signal (SSS) may be received from the base station, such that the radio frame and subframe synchronization may be acquired from the base station. Further, in the embodiment, it is also possible to receive the additional synchronization signal. The additional synchronization signal may be the extended synchronization signal (ESS), and the synchronizing signal may include the beam information. The beam information may include the beam ID information.

In step 1910, the terminal may acquire the detailed beam information from the base station and perform the beam performance refinement based thereon. More specifically, the base station may transmit the signal for the beam refinement to the terminal, and the terminal may measure the signal quality for each beam based on the signal. In the embodiment, the beam refinement signal may include at least one of the beam refinement signal (BRS) and the beam refinement reference signal (BRRS), and the beam refinement signal may be transmitted in all the subframes or in the subframe determined by the preset rules. The preset rule may be transmitted to the terminal by the higher signaling including the system information and the RRC signaling.

In step 1915, the terminal may receive the essential system information from the base station. The essential system information may be transmitted in the broadcast type. In the embodiment, the essential system information includes essential information for a post operation through the signal such as the master information block (MIB). In addition, the essential system information may acquire the system frame number, the downlink bandwidth or paging assistance information (cell ID, TRP ID, etc.), the paging indication information (whether the paging for each paging group arrives), etc. For example, the paging indication information is information indicating whether there is paging in some of the specific terminal groups for the time set by the system. In other words, if it is divided into 10 groups based on the last digits 0 to 9 of international mobile subscriber identity (IMSI) among the IDs of the terminal, bitmaps corresponding thereto are assigned to receive values of corresponding bits for each group, thereby determining whether the paging is received in the group included therein. Alternatively, the corresponding group and the number of groups may be not only divided not only based on the terminal ID but may also be divided based on the service or geographical location to which the terminal belongs, system characteristics, other QoS related characteristics, and specific groups that are designated by the base station and a provider. In addition, in the method for indicating the activity of the corresponding group, it may be a specific bit string as well as a bitmap, and it may also instruct whether the paging is received through one bit in a plurality of groups. In this way, it is possible to prevent resources from transmitting the system information from being wasted by transmitting only the essential system information in the broadcast type.

In step 1920, the terminal and the base station may perform the beam information modification. The operation may be selectively performed depending on whether a specific condition is satisfied or not. More specifically, the terminal may determine whether the state of the beam, which has been used in the past, satisfies predetermined criteria, based on the beam information used for signal transmission/reception with the base station. If the state of the beam is equal to or smaller than a predetermined level, the terminal may acquire the beam information satisfying the best signal quality based on the signal for the received beam refinement, etc., and feed back the information to the base station. A method for acquiring a best beam will be described in the following embodiment. The base station receives the feedback, and if the terminal determines that the fed back beam is suitable to use the signal transmission/reception, the base station may transmit grant information on the fed back information of the terminal to the terminal. In this way, the terminal may select the best beam by utilizing at least one of the beam information and the beam refinement signal that have been used conventionally. The grant information may include the beam information selected based on the feedback information of the terminal, and may include at least one beam information.

In step 1925, the terminal may receive the paging information from the base station based on the grant information. More specifically, the terminal may receive the paging information through the beam that is approved for use by a base station. At this time, the number of beams by which the paging is received may be plural, at least one beam having a size equal to or larger than a specific signal level may be selected or the beams to which the paging is transmitted may be a value determined based on a certain number that is designated by the base station, and a beam having at least N higher quality selected by the base station among the beams arranged in the order of quality may be selected. In this way, since the paging information may not be received by all the terminals within the cell related to the base station but the signal may receive through the specific beam, the beam resource may be more efficiently utilized in the same frequency domain at the same time.

In step 1930, the terminal may receive the remaining system information. Herein, the essential system information may be system information used for performing the operations up to step 1925, and the remaining system information may be system information used for performing the subsequent operations. Further, the remaining system information may be received through the at least one beam selected. It is possible to efficiently use resources for broadcast by receiving the remaining system information through the selected beam.

In step 1935, the terminal may perform an RRC connection establishment procedure according to its own state or the S1 connection. If there is the connection related to S1, the terminal performs the connection through the RRC connection resume, and if there is no S1 connection, the terminal may perform the S1 connection through the RRC connection establishment request procedure.

In step 1940, the terminal may check the signal quality to acquire the information of the beam of candidates for communication and feedback the information to the base station. More specifically, the terminal periodically or aperiodically measures the signal quality based on the beam used for the signal transmission/reception with the base station, and may determine whether a radio link failure has occurred. The signal measurement may be performed based on at least one of a reference signal, a data signal, a synchronization signal, and a beam refinement signal. Also, a threshold value corresponding to the signal quality may be set according to the embodiment of the present disclosure, and the threshold value may be performed differently according to the state of the terminal. Further, the terminal may report the acquired beam-related information to the base station periodically or aperiodically.

In step 1945, the base station and the terminal may perform the RRC connection release operation. According to the embodiment of the present disclosure, the RRC connection release/suspend message may be transmitted to the terminal. Further, the message including the beam information and the related information used for the signal transmission/reception by the base station and the terminal may be transmitted to the terminal. The related information may include at least one of a transmission reception point (TRP), a transmission reception point group (TRPG), and cell information that are used for the signal transmission/reception with the terminal. The terminal may store the information and may perform the beam selection based on the information when accessing the corresponding base station.

Further, in the embodiment of the present disclosure, at least one of the paging information or the system information may also be transmitted using the beam information.

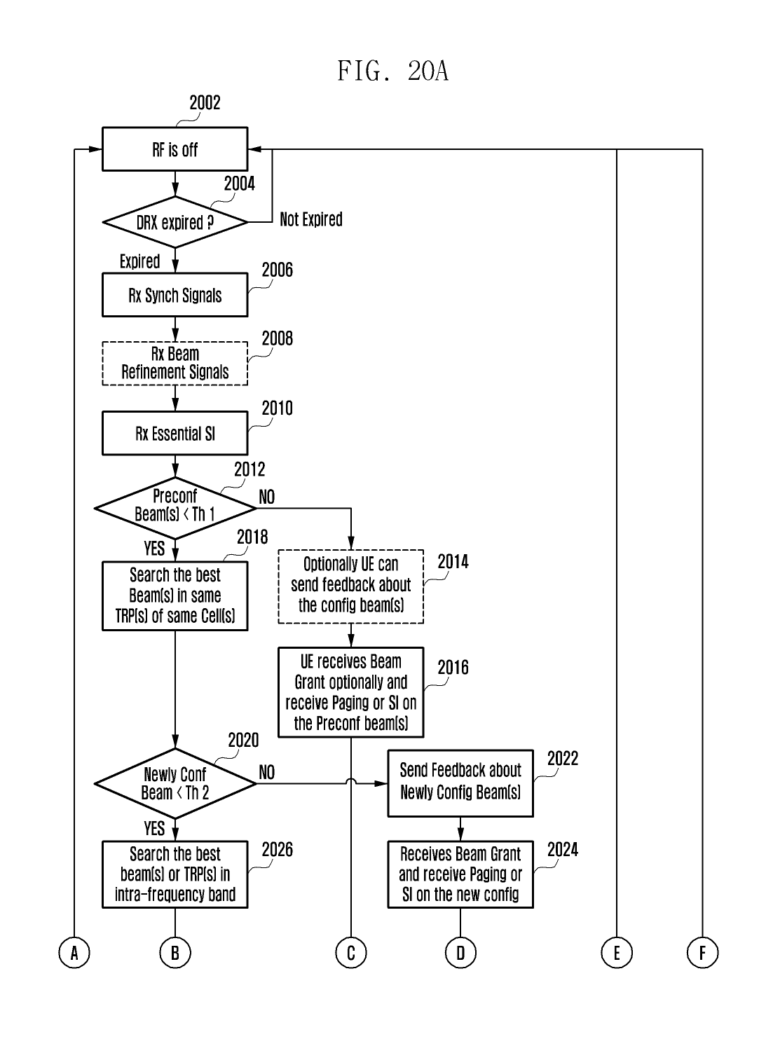

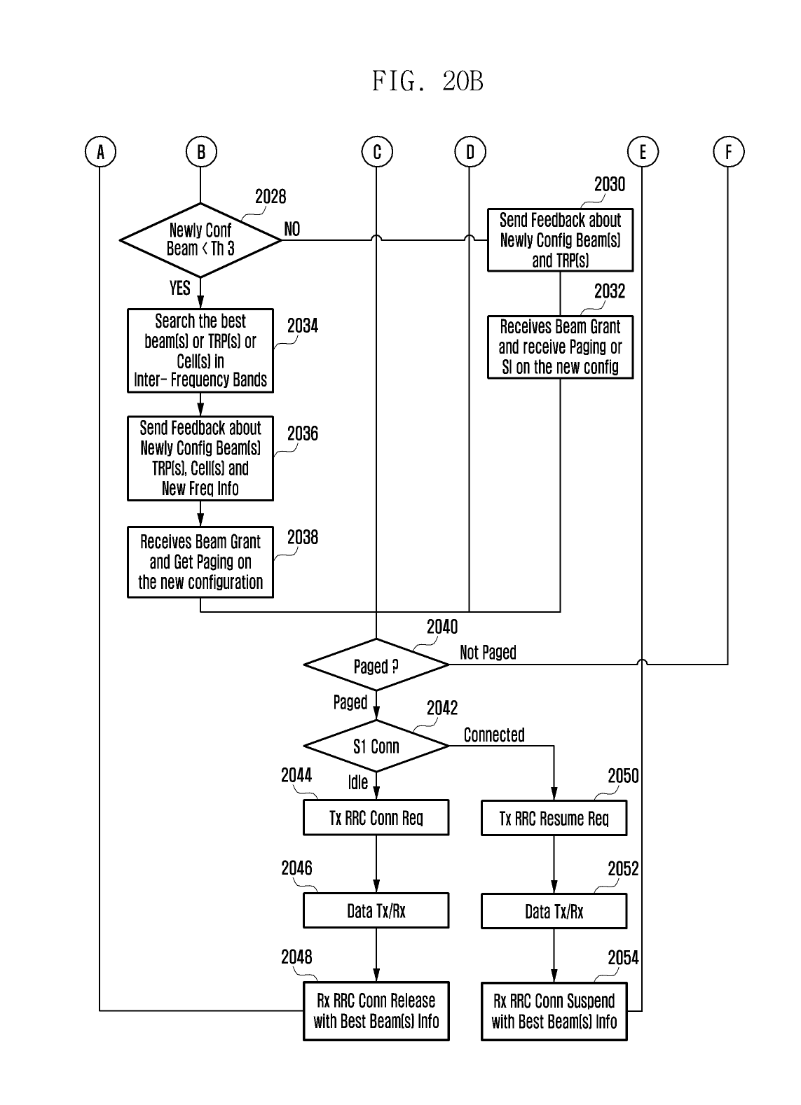

FIGS. 20A and 20B are diagrams illustrating a method for operating a terminal for connecting a terminal in an idle state to a system.

Referring to FIGS. 20A and 20B, the terminal may access a communication system through the base station.

In step 2002, an RF state of the terminal may be off. Even in the case, it is possible to perform an operation for transmitting and receiving a signal to and from the base station.

In step 2004, the terminal may determine whether a DRX period has expired. If it is determined that the DRX period has not expired, the RF maintains the off state, and if it is determined that the DRX period has expired, in step 2006, the synchronization signal may be received. A method for acquiring synchronization may include the method described in the previous embodiment.

In step 2008, the terminal may receive a signal for the beam refinement from the base station. The signal for the beam refinement may include a reference signal.

In step 2010, the terminal may receive the essential minimum SI for communication performance from the base station. In the embodiment, the minimum SI information may include information for paging reception such as the paging area ID, the cell ID, and the TRP ID and a basic idle mode operation. In the embodiment, the minimum SI information may be received by a higher signal.

In step 2012, the terminal may determine the beam performance based on the beam information previously used for the signal transmission/reception with the base station. The base station and the terminal may share the beam information previously used. As described in the previous embodiments, if the RRC release or the like is performed, the beam information last used may be transmitted to the terminal, and the terminal may preferentially consider the corresponding beam after performing the communication with the base station based thereon. Further, the terminal may determine whether the previously used beam performance is less than a preset threshold value 1. The performance determination may be performed based on the beam refinement signal received from the base station. If the beam performance is not equal to or less than the threshold value 1, in step 2014, the terminal may transmit the feedback information related to the previously used beam to the base station and in step 2016, may receive at least one of the grant information corresponding to the feedback information, the paging related information, and the SI from the base station through the previously used beam. In the embodiment, the operations of steps 2014 and 2016 may be selectively performed, and if the terminal sends the feedback information, the paging related information may be received from the base station directly through the corresponding beam without any additional grant. In the embodiment, the threshold value 1 may be transmitted in advance from the base station through the system information, and the value may be set based on reference signal received power (RSRP) or reference signal received quality (RSRQ).

If the beam performance is less than the threshold value 1, in step 2018, the best beam may be searched in the same cell and in the same TRP. In step 2020, the terminal may determine whether the performance of the beam selected within the same cell and the same TRP is less than a threshold value 2. If the beam performance is not less than the threshold value 2, in step 2022, the feedback for the selected beam may be sent to the base station, and in step 2024, the grant information and at least one of the paging information and the other SI information from the granted beam may be received from the base station.

If the best beam within the same cell and the same TRP is below the threshold value 2, in step 2026, the best beam or the TRP may be searched within the same frequency. In step 2028, the terminal may determine whether the performance of the beam selected within the same frequency is less than a threshold value 3. If the beam performance is not less than the threshold value 3, in step 2030, the feedback for the selected beam may be transmitted to the base station, and in step 2032, the grant information and at least one of the paging information and the other SI information from the granted beam may be received from the base station.

If the best beam within the same frequency is less than the threshold value 3, in step 2034, at least one of the best beam, the best TRP, and the best cell may be searched in an inter frequency band. In step 2036, the feedback for at least one of the selected beam, the TRP, and the cell may be transmitted to the base station, and in step 2038, the grant information and at least one of the paging information and the other SI information from the granted beam may be received from the base station.

In step 2040, the terminal may determine whether the paging related signal is received from the base station. If it is determined that the paging related signal is not received, it may proceed to step 2002 again and wait for the DRX period to end.

If the paging signal is received, in step 2042, the terminal may determine the current S1 connection state. If the terminal is in the idle state, the terminal may transmit the RRC connection request message to the base station in step 2044, perform the connection based on the RRC connection request message, and then may transmit/receive data in step 2046. Further, if the data transmission and reception ends, in step 2048, the RRC connection release message may be received. The RRC connection release message may include at least one of beam information for transmitting and receiving a signal with the base station and beam information recently fed back. The beam information may include at least one of the beam information used for the RRC connection release, beam information newly updated, the TRP information, the cell information, and the frequency information.

If the terminal is in the connected state, in step 2050, the terminal may transmit the RRC connection resume message to the base station, perform the connection based on the RRC connection resume message, and then transmit/receive data in step 2052. Further, if the data transmission/reception ends, in step 2054, the RRC connection suspend message may be received. The RRC connection suspend message may include at least one of beam information for transmitting and receiving a signal with the base station and beam information recently fed back. The beam information may include at least one of the beam information used for the RRC connection suspend, beam information newly updated, the TRP information, the cell information, and the frequency information.

In the embodiment, the threshold values 1 to 3 may be the same value or different values and may be received from the base station by a higher layer signal or received through the control information, and the value may be set based on the reference signal received power (RSRP) or the reference signal received quality (RSRQ).

Further, if the terminal feeds back the beam information to the base station, the terminal may acquire the quality information of the beam corresponding to the previously set beam ID based on signal quality values such as the RSRP and the RSRQ through the beam refinement signal received from the base station. Further, if the corresponding beam quality value is equal to or less than a predetermined threshold value, a best beam search may start. Here, the threshold value may be set in various stages depending on an operation option and mode. That is, if a preference for the beam within the same TRP or the same cell is set, the corresponding beam may be selected preferentially, and the corresponding TRP may be selected with different priorities. More specifically, if the beam selection is determined, the offset information may be set and weights may be differently given to the previously used beam or the beam of the same TRP.

More specifically, the beam satisfying the following expression may be selected.

<B-Criteria>

The beam reselection criterion B is fulfilled when:

Brxlev>BSearchP AND/OR Bqual>BSearchQ

Here, Brxlev is a value generated based on the RSRP, and Bqual is a value generated based on the RSRQ.

Further, the values of the Brxlev and the Bqual may be determined based on the following criteria.

Brxlev=Qrxlevmeas−(Qrxlevmin+Qrxlevminoffset)−Pcompensation−Qoffsettemp

Bqual=Qqualmeas−(Qqualmin+Qqualminoffset)−Qoffsettemp

At least one of each component parameter of the Brxlev and the Bqual may be missed, and the component parameters may be replaced by other factors having identical and similar functions.

The meaning of each component parameter is as follows.

TABLE 2

| | |
|---|---|
| B_{SearchP} | Beam search threshold for RSRP |
| B_{SearchQ} | Beam search threshold for RSRQ |
| Brxlev | Beam selection RX level value (dB) |
| Bqual | Beam selection quality value (dB) |
| Qoffsetₜₑₘₚ | Offset temporarily applied to a beam (dB) |
| | The corresponding value may be set in a provider or a base station |
| | according to a cell loading situation or a traffic congestion situation. |
| | Further, the corresponding value may be set for each beam, set for each |
| | TRP to which the corresponding beam belongs, and set for each cell. |
| Qᵣₓₗₑᵥₘₑₐₛ | Measured beam RX level value (RSRP) |
| Q_{qualmeas} | Measured beam quality value (RSRQ) |
| Qᵣₓₗₑᵥₘᵢₙ | Minimum RX level in the beam (dBm) |
| Q_{qualmin} | Minimum quality level in the beam (dB) |
| Q_{rxlevminoffset} | Offset to the signalled Qᵣₓₗₑᵥₘᵢₙ taken into account in the Brxlev |
| | evaluation as a result of a periodic search for a higher priority PLMN |
| | while camped normally in a VPLMN |
| Q_{qualminoffset} | Offset to the signalled Q_{qualmin} taken into account in the Squal |
| | evaluation as a result of a periodic search for a higher priority PLMN |
| | while camped normally in a VPLMN |
| Pcompensation | If the terminal supports the additionalPmax in the NS-PmaxList, if |
| | present, in SIB1, SIB3 and SIB5: |
| | max(P_{EMAX1} − P_{PowerClass}, 0) − (min(P_{EMAX2}, P_{PowerClass}) − |
| | min(P_{EMAX1}, P_{PowerClass})) (dB); |
| | else: |
| | max(P_{EMAX1} − P_{PowerClass}, 0) (dB); |
| P_{EMAX1}, P_{EMAX2} | Maximum TX power level an terminal may use when transmitting |
| | on the uplink in the beam (dBm) defined as P_{EMAX} in [TS 36.101]. |
| | P_{EMAX1} and P_{EMAX2} are obtained from the p-Max and the NS-PmaxList |
| | respectively in SIB1, SIB3 and SIB5 as specified in TS 36.331. |
| P_{PowerClass} | Maximum RF output power of the terminal (dBm) according to |
| | the terminal power class as defined in [TS 36.101] |

If the terminal satisfies the same conditions such as the above condition <B-Criteria>, the beam quality of the other beams are checked and the highest N or the highest N or the highest one of the beams is selected and transmitted. The selection criteria may be based on the following criteria described in the B-criteria.

Brxlev=Qrxlevmeas−(Qrxlevmin+Qrxlevminoffset)−Pcompensation−Qoffsettemp

Bqual=Qqualmeas−(Qqualmin+Qqualminoffset)−Qoffsettemp

At least one of each component parameter of the Brxlev and the Bqual may be missed, and the component parameters may be replaced by other factors having identical and similar functions.

Further, the feedback message related to the beam which the terminal transmits to the base station may include at least one of the following pieces of information:
One or more beam ID or the number of beam IDs
One or more TRP ID or the number of TRP IDs
One or more TRPG ID or the number of TRPG IDs
One or more cell ID or the number of cell IDs
One or more paging area ID or the number of paging area IDs
Terminal ID
ID that may identify the terminal, affiliated group, or service
ID that may identify the mobility, traffic characteristics, or the like of the terminal

The base station may select the beam used for transmitting and receiving signals to/from the terminal based on the information included in the feedback message.

Further, in the embodiment, since the terminal needs the additional uplink transmission to feedback the beam information, it is useful to assign a channel resource for the uplink transmission. The resource may be adapted to correspond to a transmission type of an uplink reference signal, and the base station may transmit specific setup to the terminal in a resource pool selected based on contention, and the terminal may transmit may be determined, such that the terminal may determine the transmission support in the resource pool based on the setup. The uplink transmission is likely to fail due to a collision in the case of the contention basis, but an overhead of the resource assignment is small. In addition, according to the embodiment, resources may be assigned in a contention free manner. In this way, as the contention free manner, the following method may be applied:
Method for transmitting resource assignment information to the terminal through the SI. (including short random access channel+small data type)
Contention free based random access channel
Terminal initiated signal or keep alive signal of a power saving mode (PSM)
Transmit an uplink signal (PUSCH or PUCCH) through the RRC connection after the connection based or contention free based random access

In addition, the reporting procedure may be performed by the following operations.
Control the terminal operation based on a sounding reference signal (SRS) type
Recycle the existing uplink control/data signal (PUCCH, PUSCH), and for this purpose, the base station triggers the scheduling for the corresponding signal transmission.
Reporting by periodic or specified operation in a measurement reporting type

By the assignment of the information, the terminal may assign the uplink transmission resources for the feedback of the beam information.

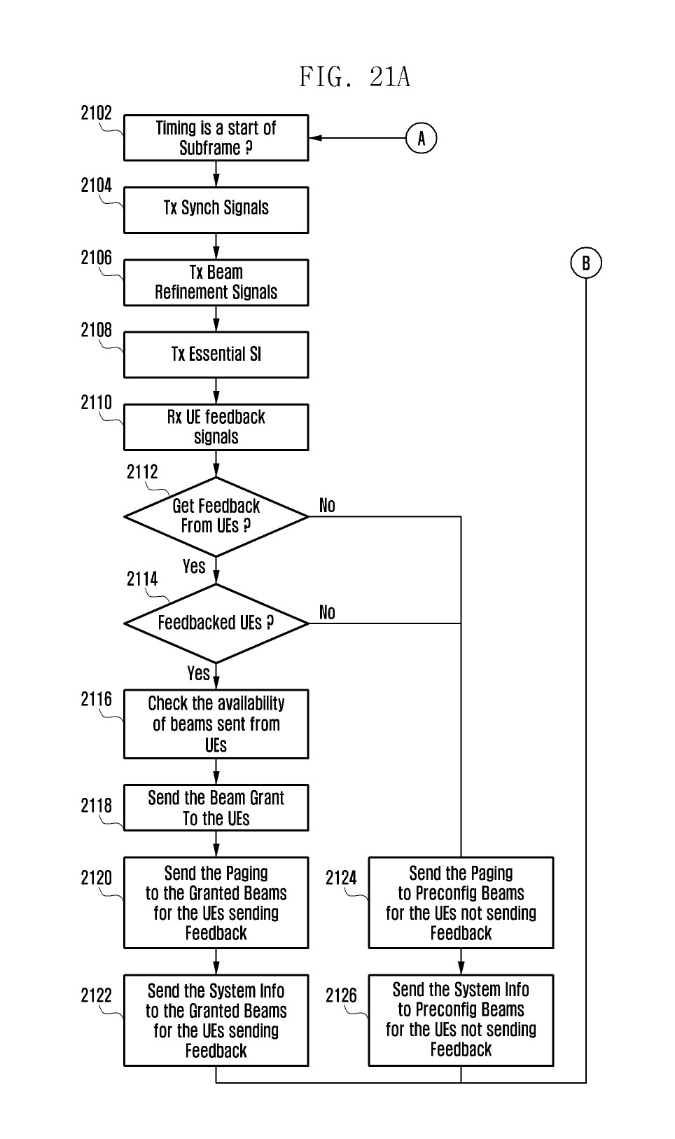

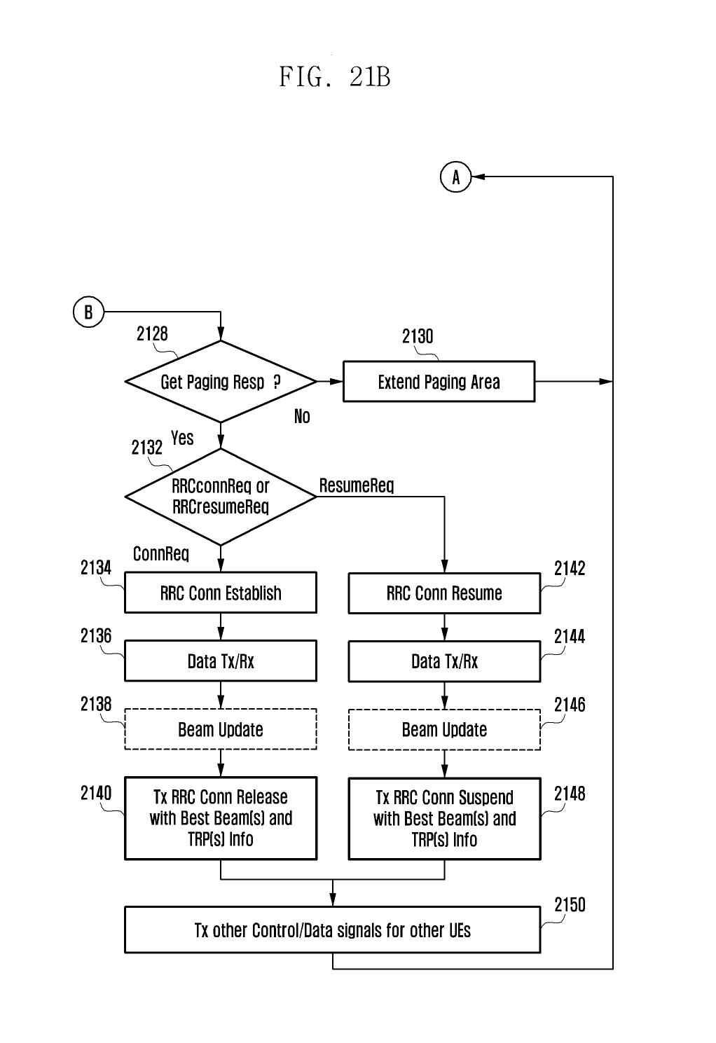

FIGS. 21A and 21B are diagrams illustrating a method for operating a system for connecting the terminal in the idle state to a system.

Referring to FIGS. 21A and 21B, the operation of the base station capable of transmitting and receiving the paging signal with the terminal starts.

In step 2102, the base station confirms the information related to the subframe period and may transmit the synchronization signal based on the information in step 2104. The synchronization signal may include at least one of PSS, SSS, and ESS.

In step 2106, the base station may transmit the signal for the beam refinement as needed. The information for the beam refinement may include reference signals for figuring out the beam information.

In step 2108, the base station may transmit the essential (minimum) SI. The minimum SI information may be transmitted in the broadcast type and include the information for the paging reception of the terminal such as the paging area ID, the cell ID, and the TRP ID and the basic idle mode operation.

In step 2110, the feedback message associated with the beam information of the terminal may wait to be received, and in steps 2112 and 2114, the base station may determine whether the feedback information is received from the terminal. The operation of the steps 2110 to 2114 may include an operation of determining whether the base station receives the beam information feedback from the terminal and waiting for a predetermined period. If the feedback is not received, the base station determines that the performance of the beam previously used by the terminal is measured as being equal to or greater than the set reference value, and then may transmit the signal based on the determination later.

If the feedback message associated with beam information is received from the terminal, in step 2116, the base station may determine whether the beam corresponding to the information fed back by the terminal is available. If available, in step 2118, the base station may transmit the grant information associated with the beam to the terminal. Further, in step 2120, the paging information may be transmitted using the granted beam, and in step 2122, the remaining system information may be transmitted using the granted beam.

If the feedback message associated with the beam information is not received from the terminal, the base station may determine that the beam previously used by the terminal is implicitly displayed as it is, in step 2124, transmit the paging message using the previously used beam, and in step 2126, transmit the remaining system information using the beam.

In step 2128, the base station determines whether the paging response message is received from the terminal. The paging response message includes at least one of the PRACH, the RRC connection request, and the RRC connection resume request message. If the paging response message is not received, in step 2130, the base station may extend a paging area to transmit the paging signal, wait for the paging response again, or return to the beginning to perform the operation again.

If the paging response is received, in step 2132, it may be determined whether the received paging response is which one of the RRC connection request or the RRC connection resume request message.

If the received paging response is the RRC connection request, in step 2134, the RRC connection establishment may be performed and in step 2136, the data may be transmitted and received. Further, the base station may also periodically/aperiodically update the beam used to transmit/receive the signal with the terminal (step 2138). In addition, when the next connection is released, in step 2140, the base station may transmit the RRC connection release message to the terminal and the message may include the beam information, the TRP information, and the cell related information that are used.

If the received paging response is the RRC connection resume request, in step 2142, the RRC connection resume may be performed and in step 2146, the data may be transmitted and received. Further, the base station may also periodically/aperiodically update the beam used to transmit/receive the signal with the terminal (step 2148). In addition, in step 2150, the base station may transmit the RRC connection suspend message to the terminal and the message may include the beam information, the TRP information, and the cell related information that are used.

The used beam or the last reported beam information that are included in the RRC connection release or the suspend may include the following information:
Beam and L1, L2 or resource usage related information to be used in next RF on or RRC connection in consideration of beam priority and beam quality
Resume ID (serving base station ID, e.g., C-RNTI, PCI information)
Multi-Antenna related setup information
Beam measurement reference signal related resource setup information (e.g., cycle, position, scheduling information, related index information)
Rx, Tx antenna setup information (e.g., how many to activate, power assignment information, various related time, frequency setup information, and related timer information)
Various mobility related setup information (e.g., wide beam or low frequency band, 3G or 4G physical resource for mobile terminals)
PHY related setup information (e.g., semi persistent scheduling setup information, scheduling setup information, e.g., the number or time of PDCCH RBs and a location on the frequency domain, various MCS configuration information, a multiple access method, 4G, 5G other technical RAT related information)
Priority information for each beam or TRP, TRPG, cell, and frequency channel s
Combination of the above terms, i.e., one or more combinations

In addition, the information transmitted in this manner may be applied based on the following rules upon the access of the terminal later.
Priority between beams is provided via SI or RRCConnectionRelease. Here, the priority between the beams refers to a method for prioritizing beams according to specific beam characteristics (direction, frequency, time interval, TRP affiliation, etc.) and selecting beams accordingly.
When provided via the SI, a beam list may be provided without the beam priority.
When provided by the dedicated signaling (e.g., RRC connection termination, abort message of RRConnectionRelease, RRConnectionSuspend, or the like), all priorities given by the SI may be ignored and applied.
When transmitting by the specific SI, all priorities given by the dedicated signaling or other SI may be ignored.

The base station may also perform the transmission and reception data with other terminals in step 2152 [nothing in drawings appears to correspond to this; request it be added to FIG. 21B?].

As described above, a technical feature of acquiring the beam information to be used and updating the beam information before the terminal and the base station make the RRC connection is disclosed. Further, it is possible to receive the paging information SI using the beam information updated in this manner. In addition, the beam selection may be performed through the information preferentially shared in a next connection by sharing the information finally used or updated after the transmission and reception of data between the base station and the terminal. Further, the technical feature that may select the beam to be used for communication with the terminal depending on the load information for each beam used by determining, by the base station, the validity of the beam is also disclosed.

Further, in the embodiment, the base station may include at least one of the following pieces of information included in the beam accept message for transmitting the beam information to be used for communication based on the beam feedback information sent by the terminal:
One or more granted beam ID or the number of granted beam IDs or indication of 1 bit or more that may identify whether grant is made
One or more granted TRP ID or the number of granted TRP IDs or indication of 1 bit or more that may identify whether grant is made
One or more granted TRPG ID or the number of granted TRPG IDs or indication of 1 bit or more that may identify whether grant is made
One or more granted cell ID or the number of granted cell IDs or indication of 1 bit or more that may identify whether grant is made
One or more granted paging area ID or the number of granted paging area IDs or indication of 1 bit or more that may identify whether grant is made
Granted terminal ID or indication of 1 bit or more that may identify whether grant is made

Granted ID that may identify a terminal, an affiliated group, or a service or indication of 1 bit or more that may identify whether grant is made
Granted ID that may identify mobility characteristics, traffic characteristics, or the like of a terminal or indication of 1 bit or more that may identify whether grant is made

Further, the beam ID may be determined as follows:

(1) Independent beam ID in independent TRP ID+TRP within cell ID+cell
In this case, the beam order in the TRP refers to an ID that may be uniquely defined independently in one TRP, and for example, if the number of beams is defined as 16 in total, it may be assigned as 4 bits and each order may be specified.
Here, an independent TRP ID in a cell refers to an ID that is uniquely defined independently in the corresponding cell ID.

(2) Independent beam ID in cell ID+cell
Here, an independent beam ID in a cell refers to an ID that is uniquely defined independently from each other within the cell.

(3) Beam ID selected in a certain sequence set
Here, the beam ID selected in the sequence set refers to the beam ID arbitrarily selected in the certain beam ID set.

Further, the beam accept message may be scheduled as follows:
Scrambling with the corresponding terminal ID to transmit the downlink control signal and transmitting a contents signal containing the above-mentioned granted beam information
Transmits a signal containing the terminal ID, the corresponding indication, and instructions in a broadcast signal form.
Transmission through PDCCH or PDSCH signal that is scheduled based on at least one of terminal ID, timing, and frequency.

FIG. 8 is a diagram illustrating a method for providing beam information according to an embodiment of the present disclosure.

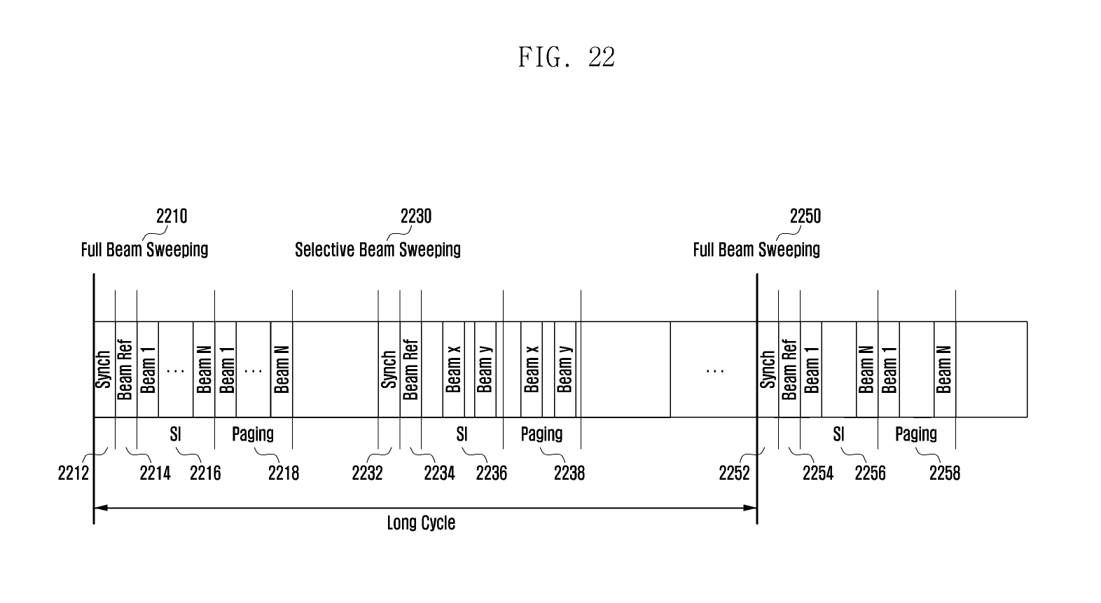

Referring to FIG. 22, a beam related signal transmission procedure is disclosed. There may be the case where the reference signal and the paging signal for the entire beam should be transmitted over a predetermined period while the terminals move within the cell. The signal transmission method will be described.

First, a synchronization signal 2212 may be transmitted first and a beam reference signal 2214 may be transmitted. The beam reference signal may be a reference signal including the information for the beam refinement. Next, SI 2216 may be transmitted using the entire beam. Next, a paging signal 2218 may be transmitted using the entire beam. Further, after a predetermined time elapses, the information about the selective beam may be transmitted again. The predetermined time may correspond to the DRX period. Even in this case, a synchronization signal 2232 may be transmitted and a beam reference signal 2234 may be transmitted. Next, SI 2236 and a paging signal 2238 may be transmitted for the selected beam. Thereafter, the selective beam information may be continuously transmitted for a predetermined period, and the information about the entire beam may be transmitted again (2252-2258) after a predetermined cycle (a long cycle in the drawing) elapses. In this manner, the paging signal and the SI are transmitted through the entire beam for the specific period, it is possible to adaptively cope with the case where the terminal additionally enters the cell. Further, the full beam sweeping may also include full sweeping in all beam directions or full transmission in all TRPs.

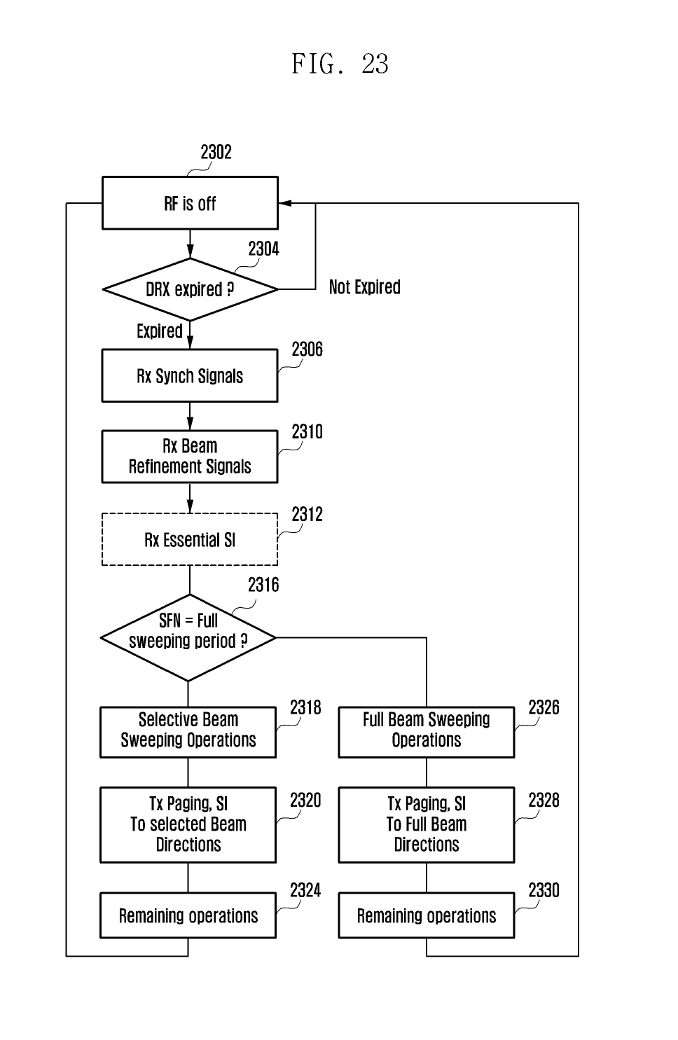

FIG. 23 is a diagram illustrating an operation of a terminal receiving beam information according to an embodiment of the present disclosure.

Referring to FIG. 23, the terminal may transmit and receive a signal to and from the base station.

In step 2302, the RF state of the terminal may be off. Even in the case, it is possible to perform an operation for transmitting and receiving a signal to and from the base station.

In step 2304, the terminal may determine whether the DRX period has expired. If it is determined that the DRX period has not expired, the RF maintains the off state, and if it is determined that the DRX period has expired, in step 2306, the synchronization signal may be received. A method for acquiring synchronization may include the method described in the previous embodiment.

In step 2310, the terminal may receive a signal for the beam refinement from the base station. The signal for the beam refinement may include the reference signal.

In step 2312, the terminal may receive the essential minimum SI for communication performance from the base station. In the embodiment, the minimum SI information may include information for paging reception such as the paging area ID, the cell ID, and the TRP ID and a basic idle mode operation. In the embodiment, the minimum SI information may be received by the higher signal.

In step 2316, the terminal may determine whether it is a full sweeping period based on the SFN. The full sweeping period may also be set depending on the predetermined information or may also be set through the minimum SI information.

If it is not the full sweeping period, in step 2318, the sweeping operation for the selected beam is performed, in step 2320 the paging and the SI may be received through the selected beam, and then in step 2324, the foregoing operation may be performed.

If it is the full sweeping period, in step 2326, the full sweeping operation may be performed. In this case, the terminal may receive signals not only in its own beam direction but also in other beam direction, and may not perform UL feedback for updating the best beam information in some cases. Further, in step 2328, the SI and the paging signal may be received over the entire beam, and in step 2330, the foregoing operations may be performed.

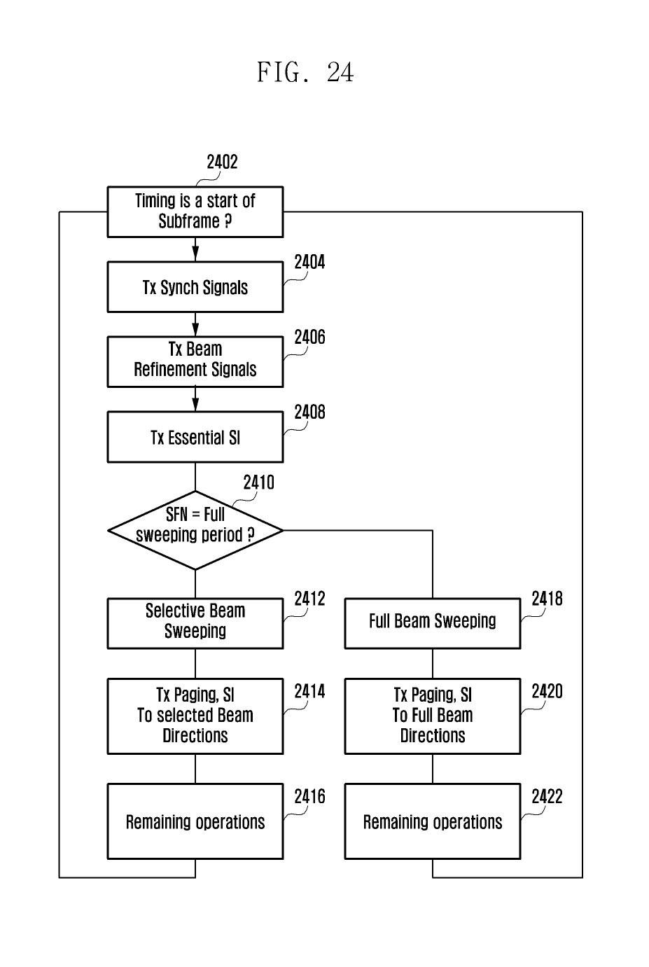

FIG. 24 is a diagram illustrating an operation of a base station transmitting beam information according to an embodiment of the present disclosure.

Referring to FIG. 24, the terminal may transmit and receive a signal to and from the base station.

In step 2402, the base station confirms the information related to the subframe period and may transmit the synchronization signal based on the information in step 2404. The synchronization signal may include at least one of PSS, SSS, and ESS.

In step 2406, the base station may transmit the signal for the beam refinement as needed. The information for the beam refinement may include reference signals for figuring out the beam information.

In step 2408, the base station may transmit the essential (minimum) SI. The minimum SI information may be transmitted in the broadcast type and include the information for the paging reception of the terminal such as the paging area ID, the cell ID, and the TRP ID and the basic idle mode operation.

In step 2410, the base station may determine whether it is a full sweeping period based on the SFN. The full sweeping period may also be set depending on the predetermined information or may also be set through the minimum SI information.

If it is not the full sweeping period, in step 2412, the sweeping operation for the selected beam is performed, in step 2414, the paging and the SI may be transmitted through the selected beam, and then in step 2416, the foregoing operation may be performed.

If it is the full sweeping period, in step 2418, the full sweeping operation may be performed. At this time, the base station may transmit the signal in its own entire beam direction. Further, in step 2420, the SI and the paging signal may be received over the entire beam, and in step 2422, the foregoing operations may be performed.

A method for transmitting and receiving a signal by a terminal of a mobile communication system according to various embodiments of the present disclosure may include receiving synchronous information from a base station, acquiring beam information, and receiving at least one of paging information and system information based on the acquired beam information.

The acquiring of the beam information may include acquiring the beam information based on information included in a radio resource control (RRC) message received from the base station.

The acquiring of the beam information includes acquiring information related to a beam satisfying a reference value among a plurality of beams based on predetermined priority information.

The method may further include transmitting feedback information related to the acquired information to the base station.

The acquiring of the beam information may include determining whether it corresponds to a specific period and if it is determined that it corresponds to the specific period, receiving information on all the settable beams.

The method may further include acquiring additional beam information if the acquired beam information does not satisfy a predetermined reference.

A method for transmitting and receiving a signal by a base station of a mobile communication system according to various embodiments of the present disclosure may include transmitting synchronous information from a terminal, transmitting a signal related to beam information, and transmitting at least one of paging information and system information based the beam information.

The transmitting of the signal related to the beam information may include transmitting the beam related information to the radio resource control (RRC) message.

The method may further include receiving feedback information related to the beam information acquired from the terminal, in which the acquired beam information may include the information related to the beam satisfying the reference value among the plurality of beams based on the predetermined priority information.

The transmitting of the signal related to the beam information may include determining whether it corresponds to a specific period and if it is determined whether it corresponds to the specific period, transmitting information on all the settable beams.

The method may further include receiving additional beam information from the terminal if the beam information acquired by the terminal does not satisfy the predetermined reference.

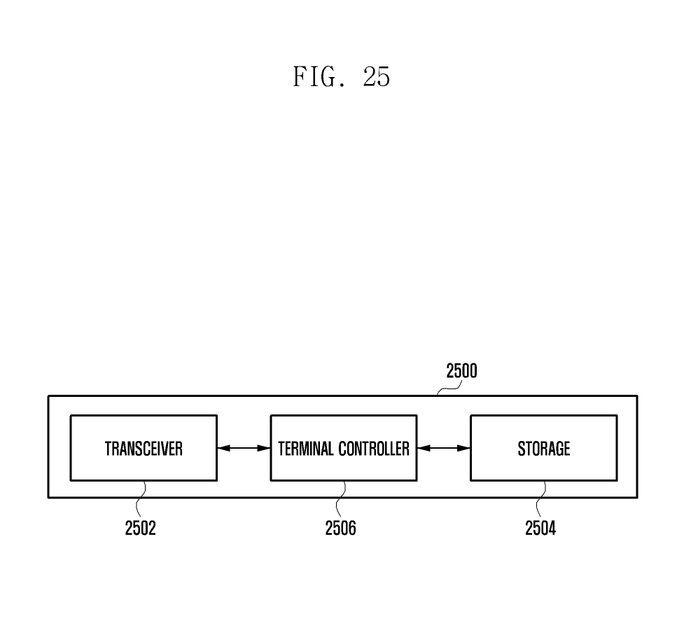

FIG. 25 is a diagram illustrating a terminal according to an embodiment of the present disclosure.

According to the embodiment, a terminal 2500 may include a transceiver 2502, a storage 2504, and a controller 2506 for controlling them.

The transceiver 2502 may transmit and receive a signal to and from the base station or another terminal, and may include the existing wired and wireless transmitting and receiving device. Further, the transceiver 2502 may transmit and receive a signal depending on the beam information based on the control of the controller 2506.

The storage 2504 may store the information associated with the terminal or the information associated with another node for performing communication or store at least one of the information transmitted and received through the transceiver 2502.

The controller 2506 controls the operation of the terminal and may control other components of the terminal to perform the operation of the terminal described in the embodiment.

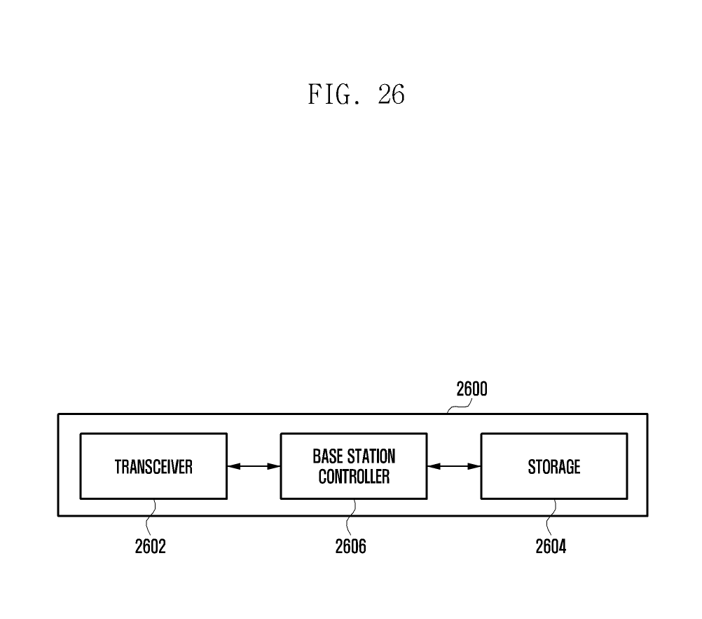

FIG. 26 is a diagram illustrating a base station according to an embodiment of the present disclosure.

According to the embodiment, a base station 2600 may include a transceiver 2602, a storage 2604, and a controller 2606 for controlling them.

The transceiver 2602 may transmit and receive a signal to and from another base station, another terminal, or a network node, and may include the existing wired and wireless transmitting and receiving device. Further, the transceiver 2602 may transmit and receive a signal depending on the beam information based on the control of the controller 2606.

The storage 2604 may store the information associated with the base station or another node transmitting and receiving a signal and store at least one of the information transmitted and received through the transceiver 2602.

The controller 2606 controls the operation of the base station and may control other components of the terminal to perform the operation of the base station described in the embodiment.

Each of the foregoing components of an electronic device according to various embodiments of the present document may be configured as one or more component and names of the corresponding components may be changed according to a kind of electronic devices. The electronic device according to various embodiments of the present disclosure may be configured to include at least one of the foregoing components and may not have some components or may further include other additional components. Further, some of the components of the electronic device according to various embodiments of the present disclosure are combined to be configured as one entity and thus may identically perform the functions of the corresponding components before being combined.

The terms “˜unit”, “device”, or “module” used in various embodiments of the present disclosure may mean a unit including one or at least two combinations of hardware, software, and firmware. The “˜unit”, “device”, or “module” may be interchangeably used with the terms such as “unit”, “logic”, “logical block”, “component”, and “circuit” The “˜unit”, “device”, or “module” may be a minimum unit of components integrally configured or some thereof. The “˜unit”, “device”, or “module” may also be a minimum unit performing one or more function or some thereof. The “˜unit”, “device”, or “module” may be implemented mechanically or electronically. For example, the “unit”, “device”, or “module” according to various embodiments of the present disclosure may include at least one of an application-specific integrated circuit (ASIC), field-programmable gate arrays (FPGAs), and a programmable-logic device that are known, will be developed in future, and perform any operations.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for paging using beamforming by a base station in a wireless communication system, comprising:
determining a paging option for a terminal based on at least one of whether a cell is in a dormant mode, information on a number of terminals within the cell, or traffic load information of the cell;
notifying the terminal of information on the determined paging option; and
performing a paging operation on the terminal based on the determined paging option.

2. The method of claim 1, wherein the paging option includes full sweep paging or dedicated paging.

3. The method of claim 2, wherein in the determining of the paging option, if the cell is not in the dormant mode, and if the number of terminals within the cell is over a first predetermined value or the traffic load of the cell is below a second predetermined value, the paging option is determined as the full sweep paging.

4. The method of claim 2, wherein in the determining of the paging option, if the cell is in the dormant mode, and if the number of terminals within the cell is below a first predetermined value or the traffic load of the cell is over a second predetermined value, the paging option is determined as the dedicated paging.

5. The method of claim 3, wherein if the paging option is determined as the full sweep paging, the performing of the paging includes:
transmitting common control information to the terminal by a full beam sweep;
transmitting a paging message to the terminal by the full beam sweep;
receiving a feedback from the terminal by a dedicated beam sweep if the terminal is a paging target; and
transmitting dedicated control information to the terminal transmitting the feedback by the dedicated beam sweep.

6. The method of claim 4, wherein if the paging option is determined as the dedicated paging, the performing of the paging includes:
transmitting common control information to the terminal by a full beam sweep;
receiving a feedback from the terminal by the a dedicated beam sweep;
transmitting a paging message to the terminal by the dedicated beam sweep; and
transmitting dedicated control information to the terminal by the dedicated beam sweep if the terminal is a paging target.

7. The method of claim 1, wherein the paging option is determined periodically or if a specific event occurs, and
the specific event includes at least one of a change of whether the cell is in the dormant mode, a change of the information on the number of terminals in the cell, or a change of the traffic load information of the cell.

8. A base station supporting beamforming in a wireless communication system, comprising:
a transceiver; and
at least one processor configured to:
determine a paging option for a terminal based on at least one of whether a cell is in a dormant mode, information on a number of terminals within the cell, or traffic load information of the cell;
notify the terminal of information on the determined paging option; and
perform a paging operation on the terminal based on the determined paging option.

9. The base station of claim 8, wherein the paging option includes full sweep paging or dedicated paging.

10. The base station of claim 9, wherein the at least one processor is configured to determine the paging option as the full sweep paging, if the number of terminals within the cell is over a first predetermined value or the traffic load of the cell is below a second predetermined value, and if the cell is not in the dormant mode.

11. The base station of claim 9, wherein the at least one processor is configured to determine the paging option as the dedicated paging, if the number of terminals within the cell is below a first predetermined value or the traffic load of the cell is over a second predetermined value, and if the cell is in the dormant mode.

12. The base station of claim 10, wherein if the paging option is determined as the full sweep paging, the at least one processor is configured to:
control the transceiver to transmit common control information to the terminal by a full beam sweep;
transmit a paging message to the terminal by the full beam sweep;
receive a feedback from the terminal by a dedicated beam sweep if the terminal is a paging target; and
transmit dedicated control information to the terminal transmitting the feedback by the dedicated beam sweep.

13. The base station of claim 11, wherein if the paging option is determined as the dedicated paging, the at least one processor is configured to:
control the transceiver to transmit common control information to the terminal by a full beam sweep;
receive a feedback from the terminal by the full beam sweep;
transmit a paging message to the terminal by a dedicated beam sweep; and
transmit dedicated control information to the terminal by the dedicated beam sweep if the terminal is a paging target.

14. The base station of claim 8, wherein the at least one processor determines the paging option periodically or if a specific event occurs, and
the specific event includes at least one of a change of whether the cell is in the dormant mode, a change of the information on the number of terminals in the cell, or a change of the traffic load information of the cell.

15. A method for paging using beamforming by a terminal in a wireless communication system, comprising:
receiving information on a determined paging option from a base station; and
receiving a paging message from the base station based on the paging option,
wherein the determined paging option is based on at least one of whether a cell is in a dormant mode, information on a number of terminals within the cell, or traffic load information of the cell.

16. A terminal supporting beamforming in a wireless communication system, comprising:
a transceiver; and
at least one processor configured to:
control the transceiver to receive information on a determined paging option from a base station; and
control the transceiver to receive a paging message from the base station based on the paging option,
wherein the determined paging option is based on at least one of whether a cell is in a dormant mode, information on a number of terminals within the cell, or traffic load information of the cell.

17. The method of claim 15, wherein the paging option includes full sweep paging or dedicated paging.

18. The terminal of claim 16, wherein the paging option includes full sweep paging or dedicated paging.

19. The method of claim 5, wherein the performing of the paging further includes performing a random access procedure with the terminal.

20. The method of claim 6, wherein the performing of the paging further includes performing a random access procedure with the terminal.
